(19) United States
(12) Patent Application Publication
(10) Pub. No.: US 2026/0099747 A1
(43) Pub. Date: Apr. 9, 2026

(54) TECHNIQUES FOR CALIBRATING CONTROL OF A QUANTUM INFORMATION PROCESSOR

(71) Applicant: ColdQuanta, Inc., Boulder, CO (US)

(72) Inventors: Daniel C. Cole, Boulder, CO (US); David Robert Mason, Denver, CO (US); Mark Saffman, Madison, WI (US)

(73) Assignee: ColdQuanta, Inc., Boulder, CO (US)

(21) Appl. No.: 18/909,375

(22) Filed: Oct. 8, 2024

Related U.S. Application Data
(60) Provisional application No. 63/543,259, filed on Oct. 9, 2023.

(51) Int. Cl. G06N 10/40; G06N 10/20

(52) U.S. Cl. CPC G06N 10/40; G06N 10/20

(57) ABSTRACT

Techniques are described for efficient calibration of control parameters of a quantum information processor. The techniques include executing a quantum circuit a plurality of times while varying the value of a control parameter that parameterizes the quantum circuit. The quantum circuit may include quantum gates and/or other operations that are expected to produce a particular result when the control parameter is properly calibrated. By varying the value of the control parameter between successive executions of the quantum circuit, a calibrated value of the control parameter may be determined. Control parameters may, for instance, have values associated with a particular qubit, or with a particular pair (or larger group) of qubits.

### CROSS-REFERENCE TO RELATED APPLICATIONS

The present application claims the benefit under 35 U.S.C. § 119 (e) of U.S. Provisional Patent Application No. 63/543,259, filed Oct. 9, 2023, titled “Methods for Maintaining the Calibration of a Large Quantum Processor,” which is hereby incorporated by reference in its entirety.

### BACKGROUND

Quantum computing platforms promise to provide solutions to many computationally intractable problems. In a quantum computing platform, information is stored in quantum bits or “qubits,” and the power of the platform generally increases with the number of qubits that can be independently and simultaneously controlled. In quantum computing platforms comprising qubits such as trapped ions or neutral atoms, directed electromagnetic waves (e.g., microwaves, optical beams) implement independent qubit manipulations, while platforms comprising qubits such as electron dots or superconducting rings use guided RF or microwave beams.

Quantum information processing with neutral atoms offers many exciting opportunities. Neutral atoms can be trapped in flexible geometries and in large numbers using optical trapping techniques. Each individual atom can store a quantum bit of information in stable electronic energy levels, such as two hyperfine ground state energy levels. Such storage has the advantage of long coherence times, enabled by excellent isolation from the environment, near-perfect qubit initialization via optical pumping, individual optical readout of each qubit, and straightforward manipulation of single qubits.

### SUMMARY

According to some aspects, a method is provided comprising determining calibrated values of a first control parameter for each qubit of a plurality of qubits, the plurality of qubits including a first set of qubits and a second set of qubits disjoint from the first set of qubits, wherein determining the calibrated values of the first control parameter for each qubit of the plurality of qubits comprises executing a first sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit, and concurrently with executing the first sequence of the quantum circuit on the first set of qubits, executing a second sequence of the quantum circuit on the second set of qubits using the quantum information processor, wherein the quantum circuit is executed with a plurality of different values of the first control parameter when executing the second sequence of the quantum circuit.

According to some aspects, a method is provided comprising determining calibrated values of a first control parameter for each qubit of a first set of qubits, wherein determining the calibrated values of the first control parameter for each qubit of the first set of qubits comprises executing a sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the sequence of the quantum circuit, and calculate calibrated values of the first control parameter for each qubit of a second set of qubits based on the determined calibrated values of the first control parameter for each qubit of the first set of qubits and based on at least one correlated property between the qubit of the second set of qubits and the first set of qubits.

According to some aspects, a system is provided comprising an optical system configured to trap, and manipulate quantum states of, a plurality of neutral atom qubits, wherein operation of the optical system is controlled by at least a first control parameter, and at least one controller configured to determine calibrated values of the first control parameter for each of the plurality of neutral atom qubits, the plurality of neutral atom qubits including a first set of neutral atom qubits and a second set of neutral atom qubits disjoint from the first set of neutral atom qubits, wherein determining the calibrated values of the first control parameter for each neutral atom qubit of the plurality of neutral atom qubits comprises executing a first sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit, and concurrently with executing the first sequence of the quantum circuit on the first set of neutral atom qubits, executing a second sequence of the quantum circuit on the second set of neutral atom qubits at least in part by operating the optical system, wherein the quantum circuit is executed with a plurality of different values of the first control parameter when executing the second sequence of the quantum circuit.

According to some aspects, a system is provided comprising an optical system configured to trap, and manipulate quantum states of, a plurality of neutral atom qubits, wherein operation of the optical system is controlled by at least a first control parameter, and at least one controller configured to determine calibrated values of the first control parameter for each neutral atom qubit of a first set of neutral atom qubits, wherein determining the calibrated values of the first control parameter for each neutral atom qubit of the first set of neutral atom qubits comprises executing a sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the sequence of the quantum circuit, and calculate calibrated values of the first control parameter for each neutral atom qubit of a second set of neutral atom qubits based on the determined calibrated values of the first control parameter for each neutral atom qubit of the first set of neutral atom qubits and based on at least one correlated property between the neutral atom qubit of the second set of neutral atom qubits and the first set of neutral atom qubits.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a neutral atom quantum information processor, according to some embodiments;

FIGS. 2A-2E depict a process of operating the neutral atom quantum information processor of FIG. 1, according to some embodiments;

FIG. 3A depicts energy levels of a neutral atom, according to some embodiments;

FIG. 3B depicts Rabi oscillations of a neutral atom, according to some embodiments;

FIG. 4 is a flowchart of a method of calibrating control parameters of a quantum information processor, according to some embodiments;

FIGS. 5A-5B depict an illustrative example of a sequence of quantum circuits that are desirable for calibration, according to some embodiments;

FIG. 6A depicts a Rydberg excitation operation, according to some embodiments;

FIG. 6B depicts Rydberg excitation operations that perform a CZ gate, according to some embodiments;

FIG. 7 is a flowchart of a method of calibrating control parameters of a quantum information processor through extension, according to some embodiments;

FIG. 8 depicts an array of neutral atoms, according to some embodiments;

FIG. 9 is a flowchart of a method of calibrating multiple control parameters, according to some embodiments;

FIG. 10 depicts an illustrative example of two sequences of quantum circuits, according to some embodiments; and

FIG. 11 illustrates an example of a computing system environment on which aspects of the disclosure may be implemented.

### DETAILED DESCRIPTION

The power of a quantum information processor generally increases, in part, with the number of qubits that can be independently and simultaneously controlled. It is expected, for instance, that a universal quantum information processor of useful scale will include hundreds, thousands, or possibly millions of physical qubits. Operation of such a system not only includes control of individual qubits, but also sufficient control to perform entangling operations on many groups of qubits. For instance, with N qubits for which any two qubits can be entangled in a gate, there are N(N−1)/2 two-qubit gates (e.g., almost 5000 two-qubit gates for 100 qubits).

In an ideal quantum information processor, all the qubits could be controlled in the exact same way. In reality, however, there are usually nonuniformities in the properties of qubits and/or groups of qubits as a result of factors such as their different physical locations, their interactions with inhomogeneous control fields or background fields, and/or fabrication variances. As a result, control of a quantum information processor comprising a large number of qubits may utilize different control parameters for particular qubits or groups of qubits. For example, in a quantum information processor there may be multiple control parameters for each single qubit operation, in addition to control parameters for all of the multi-qubit gates, which in sum may require many thousands of control parameters. Moreover, control parameter values may change over time, such that even a perfectly calibrated quantum information processor may be expected to slip out of calibration over time. Yet establishing and maintaining calibrated values of such a large number of different control parameters may require long and frequent maintenance procedures.

The inventors have recognized and appreciated techniques for efficient calibration of control parameters of a quantum information processor. The techniques include executing a quantum circuit a plurality of times while varying the value of a control parameter that parameterizes the quantum circuit. The quantum circuit may include quantum gates and/or other operations that are expected to produce a particular result when the control parameter is properly calibrated, although in some cases the quantum circuit may not itself be a quantum gate. By varying the value of the control parameter between successive executions of the quantum circuit, a calibrated value of the control parameter may be determined. Control parameters may have values associated with a particular qubit, or with a particular pair (or larger group) of qubits. Calibrating the control parameter may therefore include determining respective values of the control parameter for each of a plurality of qubits, or for each of a plurality of pairs of qubits, or for even larger groups of qubits.

According to some embodiments, the techniques described herein include executing a quantum circuit that includes operations performed on multiple different qubits. For instance, the quantum circuit may include: a single-qubit operation that is performed multiple times on one or more qubits, either concurrently or sequentially; and/or multi-qubit operations, such as two-qubit gates.

According to some embodiments, the techniques described herein include executing a quantum circuit that includes one or more state preparation operations, at least one quantum operation that is parameterized by a control parameter, and one or more readout operations. Such a quantum circuit may be performed numerous times while varying the value of the control parameter to determine its calibrated value.

According to some embodiments, the techniques described herein include concurrently executing a quantum circuit, which is parameterized by a control parameter, on a plurality of sets of qubits. As used herein, a “set” of qubits refers to either a single qubit or multiple qubits. Such a process in which the same quantum circuit is executed on multiple different sets of qubits may be considered distinct from the above-described instances in which the quantum circuit itself includes multi-qubit operations. For instance, a quantum circuit that includes a two-qubit gate may be executed on a set of two qubits. In addition, such a quantum circuit may be executed multiple times concurrently; e.g., on a first set of two qubits and concurrently on a second set of two qubits.

Concurrently executing a quantum circuit parameterized by a control parameter on a plurality of sets of qubits may provide for a more efficient calibration process when the sets of qubits are disjoint. For instance, when each set of qubits may be independently manipulated without affecting any of the other sets of qubits, at least with respect to the quantum circuit being executed, those sets of qubit may be described as disjoint. When the sets of qubits are disjoint, a given control parameter may be calibrated for multiple sets of qubits by concurrently executing the quantum circuit parameterized by the control parameter on the sets of qubits, resulting in a more efficient calibration process.

According to some embodiments, the techniques described herein include calibrating the value of a control parameter on a first set of qubits by executing a quantum circuit parameterized by the control parameter on the first set of qubits, and then extending the calibrated value(s) of the control parameter to a second set of qubits. For instance, calibrated values of the control parameter for the second set of qubits may be calculated by extrapolating and/or interpolating calibrated values of the control parameter for the first set of qubits. Such calculations may be based in part on some property that is correlated between the two sets of qubits. For example, if the second set of qubits has a spatial relationship to the first set of qubits, the calibrated values of the control parameter for the second set of qubits may be calculated by extrapolating and/or interpolating calibrated values of the control parameter for the first set of qubits based on their relative spatial positions. Extending calibration values in this manner may provide for a more efficient calibration process as fewer operations may be needed to calibrate a given number of qubits with respect to the control parameter.

The approach of extending calibration values from one set of qubits to another may, in at least some cases, be combined with the above-described approach of concurrently executing a quantum circuit parameterized by a control parameter on a plurality of sets of qubits. For example, the techniques described herein may include concurrently executing a quantum circuit parameterized by a control parameter on a plurality of sets of qubits, then extending calibrated values of the control parameter to an additional one or more sets of qubits.

In some embodiments, this approach may be performed multiple times for different control parameters, wherein two different quantum circuits, each parameterized by a respective control parameter, are each concurrently executed on a respective plurality of sets of qubits. For example, a first quantum circuit parameterized by a first control parameter may be executed on a first plurality of sets of qubits, while concurrently a second quantum circuit parameterized by a second control parameter is executed on a second plurality of sets of qubits. Once calibrated values of the first control parameter are determined for the first plurality of sets of qubits, values of the first control parameter may be extended to the second plurality of sets of qubits. Similarly, the calibrated values of the second control parameter may be extended to the first plurality of sets of qubits. In this manner, the first and second plurality of sets of qubits may be calibrated with respect to both the first and second control parameters.

As used herein, a “control parameter” for a quantum information processor refers to any configurable parameter that has some relationship with the quantum information processor's operation and/or performance. Control parameters may include physical properties of an output of a component of the quantum information processor, such as a frequency of a laser beam, the intensity of a laser beam, the duration of a pulse of light, the phase of a signal, the direction of a laser beam, one or more properties of a control signal such as duration, frequency, voltage, etc. Control parameters may also include hardware settings, such as a voltage, a current, a position, and/or an angle of an optical component, etc.

Control parameters can include any values, parameters, characteristics, etc. that can be measured (e.g., a voltage, a current) and that can be adjusted in some way, whether directly or indirectly. For instance, the voltage of a signal that is output by a device that is part of, or otherwise coupled to a quantum information processor, may be measurable. The voltage itself may be considered a control parameter, since adjustment of the voltage may alter the quantum information processor's operation and/or performance. Alternatively, or additionally, a setting on the device (e.g., a power level) that controls the voltage that is output may be considered a control parameter, since adjustment of this setting may also alter the quantum information processor's operation and/or performance.

Additionally, control parameters may include a proxy for another parameter, where the proxy parameter is faster or otherwise more preferable to measure than the other parameter. For instance, if a relationship can be established between two different measurable properties, and it is preferable to measure one property over the other property, the preferable property can be used as a proxy for measuring the other property, and calibrated as a control parameter. For example, where the frequency of a laser beam produced by the quantum information processor is a function of the power supplied to the laser, the power signal may be used as a proxy for the frequency of the laser. The power signal may be calibrated as a control parameter, even though the frequency of the laser is the desired property being calibrated.

Furthermore, control parameters may include non-physical parameters, such as parameters that parameterize the relationship between a physical property and a desired operation. For instance, it may be that a qubit rotation operation R(θ) can be performed for various values of θ by varying a physical property of a signal, such as its duration. Through calibration, a relationship between the physical property and the value θ may be determined, such as θ=At+B, where t is a duration of the signal. In this example, A and B are examples of non-physical control parameters that parameterize the relationship between a physical property t and the angle of rotation θ in the operation R(θ). By calibrating A and B, the duration t that will produce a desired operation R(θ) can be determined.

Following below are more detailed descriptions of various concepts related to, and embodiments of, techniques for efficient calibration of control parameters of a quantum information processor. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

In particular, examples of these and other techniques for efficient calibration of control parameters of a quantum information processor are described below with respect to a neutral atom quantum information processor. It will be appreciated that the techniques described herein are not limited to any particular type of qubit or approach to quantum information processing, and therefore the illustrated examples based on a neutral atom system are provided merely as examples of how these techniques may be implemented.

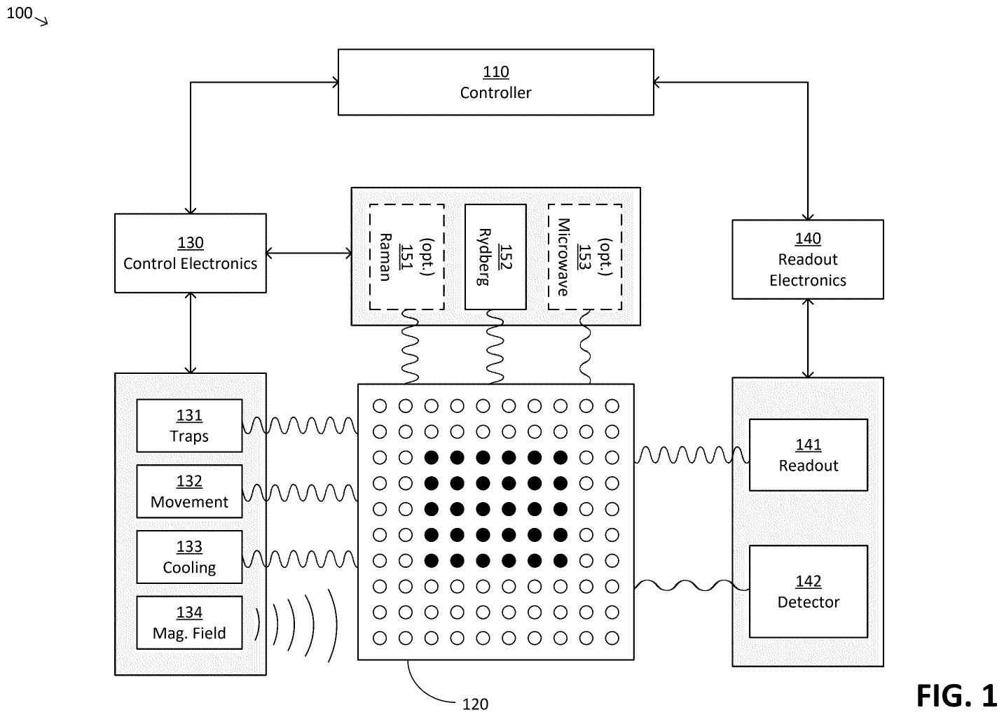

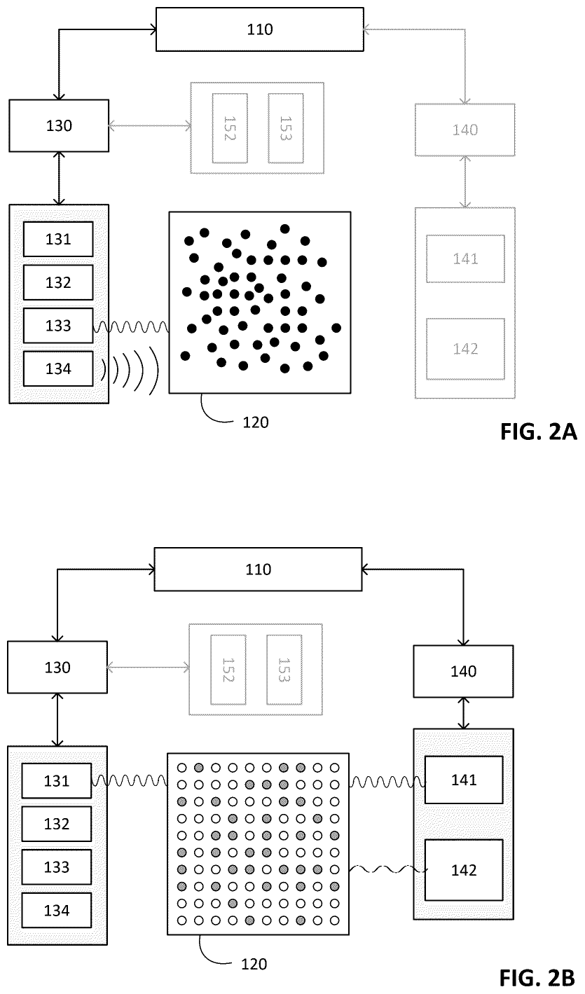

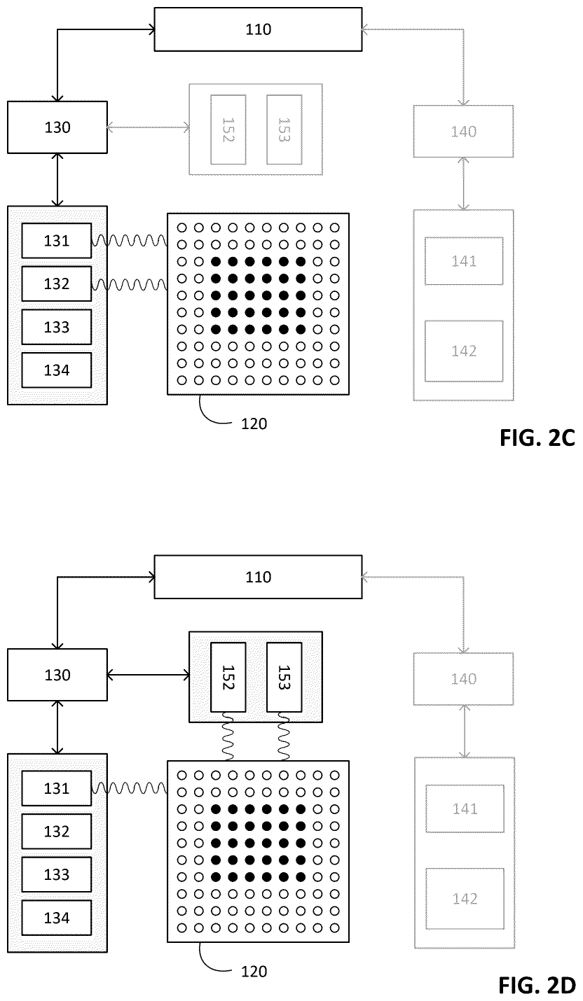

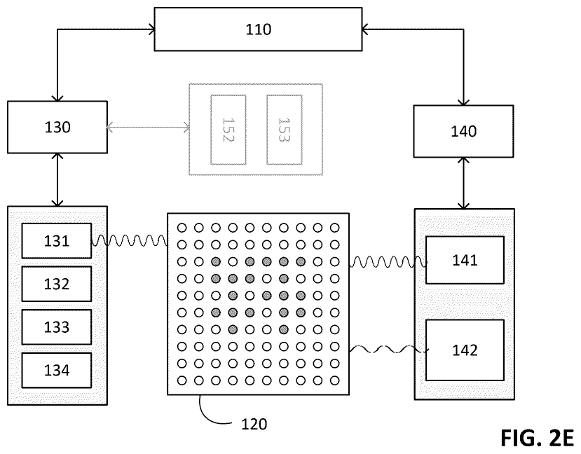

FIG. 1 is a schematic of a neutral atom quantum information processor, according to some embodiments. The illustrative quantum information processor 100 of FIG. 1 is provided as one example system in which the techniques described herein for efficient calibration of control parameters of a quantum information processor may be practiced. An example process of operating quantum information processor 100 is depicted in FIGS. 2A-2E, described below.

In the example of FIG. 1, quantum information processor 100 includes an array of neutral atoms 120, which are manipulated, and whose states are measured by, controller 110 via the control electronics 130 and/or readout electronics 140. In a neutral atom quantum information processor such as quantum information processor 100, the neutral atoms may be arranged in an array of traps, with a single atom in each trap. The atomic isotopes are chosen to have a convenient set of electronic quantum states that allow two such states to be used as computational basis states |0 [symbol] and |1 [symbol] , and that also include a Rydberg state |r [symbol] , which is an electronic state with a very high principal quantum number. The states of the atoms may be manipulated by applying electromagnetic pulses (e.g., laser light pulses of selected frequencies) to one or more selected neutral atoms. Logical gates may be performed by manipulating the quantum states of the neutral atoms, such as controlling transitions between the computational basis states |0 [symbol] and |1 [symbol] , allowing for arbitrary single-qubit gates. Entangling gates are performed by coupling one or both of the computational basis states |0 [symbol] and |1 [symbol] to the highly excited Rydberg state |r [symbol] , which produce desirable entangling interactions as a result of the Rydberg blockade effect, which inhibits two nearby atoms from occupying the Rydberg state. The neutral atoms 120 thereby operate as a type of qubit with respect to the computational basis states |0 [symbol] and |1 [symbol] , while also making use of the Rydberg state |r [symbol] . Manipulation of the quantum states of the neutral atoms 120 is described further below.

In the example of FIG. 1, the controller 110 may be configured to generate instructions that, when provided to and executed by, the control electronics 130 and readout electronics 140, perform various operations for control of the neutral atoms 120 as described below. The controller may be configured to generate such instructions using any suitable combination of software and/or hardware. According to some embodiments, controller 110 comprises software executing a general-purpose processor, an application specific integrated circuit (ASIC), a field-programmable gate array (FPGA), and/or any other suitable controller suitable for controlling the quantum information processor via control electronics 130 and readout electronics 140. In the example of FIG. 1, controller 110 may be configured to receive signals from the control electronics 130 and readout electronics 140 and to generate, based on a received signal, one or more signals to send to either or both of control electronics 130 and readout electronics 140 by executing hardware and/or software logic.

In the example of FIG. 1, the control electronics 130 and readout electronics 140 may each be implemented using any suitable combination of software and/or hardware. In some embodiments, control electronics 130 and/or readout electronics 140 may be, or may comprise, a hardware controller such as an FPGA and/or ASIC.

In the example of FIG. 1, the control electronics 130 may be configured to provide signals to the trap system 131, the movement system 132, the cooling system 133, the magnetic field system 134, the Rydberg system 152, and optionally the Raman system 151 and the microwave system 153 (collectively, the “control systems”) according to instructions and/or other signals received from the controller 110. The control electronics 130 may be configured to receive signals from any one or more of the control systems and to send a signal or signals to any one or more of the control systems and/or to controller 110 in response to a received signal. For instance, the control electronics 130 may be configured to generate, based on a received signal, one or more signals to send to any one or more of the control systems, and/or to controller 110, by executing hardware and/or software logic. For instance, the control electronics 130 may comprise an FPGA programmed to output particular signals that will result in one or more of the control systems performing one or more actions, and may do so in response to one or more signals received from any part of the quantum information processor 100.

According to some embodiments, manipulation the state of one or more of the neutral atoms 120 may be achieved through various techniques and mechanisms, and the illustrative control systems 151, 152 and 153 are depicted as examples. Some examples of operating these control systems are described below.

In the example of FIG. 1, the readout electronics 140 may be configured to provide signals to the readout system 141 and the detector 142 according to instructions and/or other signals received from the controller 110. The readout electronics 140 may be configured to receive signals from the readout system 141 and the detector 142, and to send a signal or signals to any one or more of the readout system 141, the detector 142, and/or controller 110 in response to a received signal. For instance, the readout electronics 140 may be configured to generate, based on a received signal, one or more signals to send to the readout system 141, the detector 142 and/or to the controller 110 by executing hardware and/or software logic. For instance, the readout electronics 140 may comprise an FPGA programmed to output particular signals that will result in the readout system 141 and/or the detector 142 performing one or more actions, and may do so in response to one or more signals received from any part of the quantum information processor 100.

Descriptions below relating to the quantum information processor 100 operating various elements of the system (e.g., Rydberg system 152) to perform particular operations, will be understood to refer to some combination of the control electronics 130 or readout electronics 140 providing signals to part of the quantum information processor, including but not limited to the above-noted control systems, readout system 141 and/or detector 142, whether in response to instructions and/or other signals received from the controller 110, or otherwise.

According to some embodiments, neutral atoms 120 comprises atoms of a Group I or Group II element, such as rubidium-87, cesium-133, or strontium-87. The neutral atoms may be provided as a low pressure gas (e.g., 10⁻⁸ Torr) of such atoms within a vacuum chamber. The neutral atoms 120 may be arranged in any suitable arrangement, including a two-dimensional (2D) or three-dimensional (3D) array, such as a 2D or 3D grid, by operating trap system 131 as described below.

In general, operation of the quantum information processor 100 comprises the following phases. Initially, the neutral atoms 120 are cooled then arranged in an array of traps with a single atom in each trap. This step typically also includes detecting the locations of atoms in the traps, and rearranging some atoms to produce a desired arrangement of atoms, such as the 2D grid array shown in FIG. 1. Subsequently, the quantum states of the atoms may be manipulated (e.g., to perform calculations or to perform calibration processes) through a series of operations that initialize the atoms in one of the two computational basis states |0 [symbol] and |1 [symbol] , or another desired state, and then manipulate the computational basis states |0 [symbol] and |1 [symbol] , the Rydberg state |r [symbol] , and/or any other desired state(s) of the atoms. The states of the atoms may then be measured after the operations to determine whether each atom is in the |0 [symbol] or |1 [symbol] state (although in practice there may be additional states that can, when measured, appear to the readout system as the |0 [symbol] or |1 [symbol] state; the act of measuring the states of the atoms will nonetheless generally be understood to have the goal of measuring the computational basis states).

FIGS. 2A-2E depict this process in more detail, according to some embodiments. In the example of FIGS. 2A-2E, the elements of FIG. 1 that are typically not operational in a given stage are shown greyed out for clarity. FIG. 2A represents an initial stage during which cooling system 133 and magnetic field system 134 are operated to cool and confine the neutral atoms within a desired volume.

According to some embodiments, cooling system 133 comprises one or more lasers configured to cool neutral atoms 120 to a temperature below 1 mK. For instance, cooling system 133 may operate via Doppler cooling in which a laser beam is directed onto an atom, with a frequency slightly below the resonance frequency of a particular electronic transition of the atom. The atoms will repeatedly absorb a photon of the light, losing momentum, and subsequently emit a photon in an arbitrary direction, gaining momentum. On average, because of the frequency detuning from the transition, this leads to a net momentum transfer opposite to the direction of the atom's movement, thereby reducing the speed of the atom. In some embodiments, the cooling system 133 may be configured to produce a plurality of laser beams along multiple different directions and which are configured to direct light onto the neutral atoms at a common frequency. For instance, the cooling system 133 may be configured to produce three pairs of laser beams along the directions of the six semi-axes of a 3D Cartesian coordinate system (e.g., optical molasses). In some embodiments, one or more laser beams produced by the cooling system 133, such as but not limited to the above example of three pairs of laser beams, may be circularly polarized. The cooling system 133 may be configured to produce multiple laser beams by operating multiple lasers and/or by operating suitable optical components to produce multiple laser beams from a single laser.

In some embodiments, the magnetic field system 134 comprises, or may otherwise operate, one or more magnetic field coils to produce a magnetic field within the region of the neutral atoms 120. In the examples of FIG. 1 and FIG. 2A, cooling system 133 is configured to generate a plurality of magneto-optical traps (MOTs) in part by operating the magnetic field system 134. In some embodiments, the magnetic field system 134 comprises two magnetic field coils in an anti-Helmholtz configuration and/or may be configured to produce a quadrupolar, spatially varying magnetic field. During operation, as shown in FIG. 2A, the magnetic field system 134 may be operated concurrently with the cooling system 133, thereby cooling the neutral atoms 120 via Doppler cooling using the cooling system 133, while also confining the atoms to a desired region in space.

Subsequent to or during cooling of the neutral atoms, in the example of FIG. 1 and FIG. 2B, trap system 131 may be operated to produce a plurality of traps within the space in which the neutral atoms are confined by the magnetic field system 134. The traps produced by the trap system 131 may include magnetic and/or optical traps. In some embodiments, the trap system 131 is configured to generate one or more optical tweezers (which may comprise one or more focused laser beams) that can each trap a single atom. In some embodiments, the trap system 131 is configured to produce a 2D or 3D array (e.g., a 2D or 3D grid) of traps by generating an array of optical tweezers by generating an array of focused laser beams. In some embodiments, the trap system 131 comprises one or more spatial light modulators (SLMs) that may be operated to produce traps in arbitrary positions (e.g., by generating one or more optical tweezers). Typical distances between individual traps may in some embodiments be between 1 μm and 3 μm, such as approximately 2 μm.

In some embodiments, trap system 131 comprises one or more acousto-optic deflectors (AODs) that may be operated to produce one or more traps. AODs deflect an incident laser beam into multiple beams, where the deflection angle of each beam is controlled by the acoustic wave frequencies applied to the deflector. Continuously varying the frequencies changes the deflection angles of the laser beams, reconfiguring the beams in one dimension to form traps with the beams. In some embodiments, the trap system 131 includes one or more AODs in addition to one or more SLMs. In at least some cases, traps produced by AODs may be more easily moved than traps produced by SLMs, though may have constraints on their positioning.

In some embodiments, trap system 131 may be configured to produce an optical lattice. For instance, the trap system 131 may comprise one or more acousto-optic modulators (AOMs), which may be operated to produce a spatially periodic polarization pattern that may be used to trap neutral atoms.

Frequently, not all of the traps produced by the trap system 131 will trap an atom. In some embodiments, the quantum information processor 100 may be configured to detect which of the traps contain an atom, and in response to move atoms that are detected to produce a desired arrangement of the atoms within traps. As shown in the example of FIG. 2B, the readout system 141 and detector 142 may be operated together to detect the positions of atoms within the traps produced by the trap system 131 by operating the readout system to illuminate the neutral atoms (e.g., with visible light), and detecting a result of said illumination with the detector.

In some embodiments, the readout system 141 is configured to illuminate the neutral atoms 120 with an imaging beam, such as a laser-scanning imaging beam. In some embodiments, the readout system 141 is configured to produce light with a wavelength selected to cause fluorescence of the neutral atoms 120 (e.g., a wavelength corresponding to an optical transition). The detector 142 may be configured to detect locations at which fluorescence light was produced, so that, for example, atoms are visible as bright spots, and empty traps are visible as dark spots. In the case of the neutral atoms 120 being rubidium-87 atoms, for example, the imaging beam may include light with a wavelength of 780 nm to cause fluorescence of the rubidium-87 atoms.

In some embodiments, the detector 142 comprises an optical imaging device, such as a charge coupled device (CCD), a complementary metal-oxide semiconductor (CMOS) imaging device, or an electron multiplying CCD (EMCCD) optical camera. In some embodiments, the detector 142 comprises an array of single-pixel photodetectors. In some embodiments, the detector 142 comprises a high numerical aperture (e.g., NA>0.3) lens that focuses light onto an imaging device.

Subsequent to detecting which traps contains atoms as shown in FIG. 2B, the atoms that are present may be rearranged by operating the movement system 132 and the trap system 131, as shown in FIG. 2C. For instance, the controller 110 may provide signals (e.g., data comprising or otherwise indicating executable instructions) to the readout electronics 140 that, when executed by the readout electronics, operate the readout system 141 to illuminate the neutral atoms, and to operate the detector 142 to produce imaging data indicating the positions of atoms present in the traps. The readout electronics 140 may receive the imaging data (or other data indicating the positions of atoms in the traps) and may send one or more signals to the controller 110 indicating the positions of the atoms (e.g., the imaging data or other data indicative of the positions). The controller 110 may be configured to determine a series of operations to be performed by the movement system 132 to rearrange the detected atoms, and may provide signals (e.g., data comprising or otherwise indicating executable instructions) to the control electronics 130 that, when executed by the control electronics, operate the movement system 132 and/or the trap system 131 to move one or more atoms into a new position.

There are various techniques by which atoms can be moved from a trap in one location to a trap in another location. In some embodiments, the movement system 132 is configured to operate one or more SLMs, which are producing the traps, to shift the locations of one or more of the traps, thereby carrying an atom in that trap to a new location. In some embodiments, such translations can be produced by operating the SLM to add defocus to a trap, which will shift the focus and thereby shift the trap. An alternative approach is to operate the SLM or another light source to illuminate an atom with counter-propagating beams of light with the same frequency, so that they form a standing wave. When the frequency of one of the beams is changed, the standing wave moves, carrying the atom along with it. The adjusted beam is returned to its original frequency to halt the atom transportation.

In some embodiments, the quantum information processor 100 includes traps produced by one or more AODs and the AODs may be operated to move atoms between traps. In some embodiments, the quantum information processor 100 includes traps produced by an optical tweezer (e.g., generated by one or more SLMs as described above) and traps produced by one or more AODs, and the optical tweezer and AODs may be operated to transfer atoms between the two types of traps, and to shuttle atoms around between the optical tweezer traps by adjusting the AODs to move the trap array. In some embodiments, the quantum information processor 100 may comprise one or more arbitrary waveform generators (AWGs) configured to control one or more AODs to move atoms (irrespective of whether quantum information processor 100 also includes traps produced by an optical tweezer).

Irrespective of how the atoms are rearranged, the result is a register of neutral atoms held in traps in a desired arrangement, such as the 2D array shown in FIG. 2C. Subsequently, quantum operations may be performed on the neutral atom register, including operations for calculation and/or calibration. The operation of the quantum information processor 100 to perform such operations is shown in FIG. 2D, and generally include applying laser and/or microwave pulses to one or more of the atoms to manipulate the quantum state of the one or more atoms.

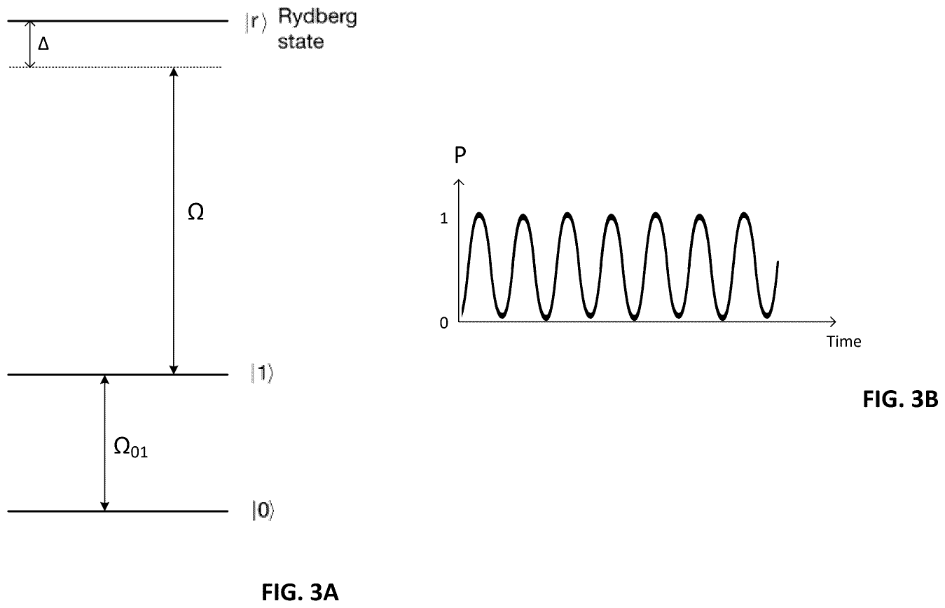

As shown in FIG. 3A, the quantum states of interest for the type of neutral atom in quantum information processor 100 include the energy levels selected to represent the computational basis states |0 [symbol] and |1 [symbol] , and the highly excited Rydberg state |r [symbol] . Driving fields applied to a neutral atom that are at or close to resonance between a pair of these energy levels excite coherent oscillations between those states, also called Rabi oscillations. The Rabi oscillations are oscillations of quantum mechanical amplitudes and expectation values of level populations, rather than discrete processes of absorption and emission of photons. The oscillating amplitudes indicate the probability of finding the atom in a certain state when the state is measured, as shown in FIG. 3B, which depict the oscillating probability of measuring the atom to be in a particular electronic state after a driving field is applied for a given amount of time. The probability shown may for example, be the probability of measuring the atom to be in the state |1 [symbol] , or the probability of measuring the atom to be in the state |r [symbol] . When the driving field is applied for a fraction of a period at the frequency of oscillation (the Rabi frequency), the atom may be placed in a superposition of states, which may be seen in FIG. 3B since the probability lies between 0 and 1 except for whole or half periods of the oscillations. In addition, a level of detuning of a driving field from a transition frequency (e.g., transition frequency Ω₀₁) will alter the Rabi frequency of the oscillations. As such, adjusting the frequency of the driving field will also adjust the quantum operation performed by the driving field. In general, a desired superposition between a pair of states can be produced by selecting the frequency, duration, intensity and/or phase of the driving field appropriately.

Transitions between the |0 [symbol] and |1 [symbol] states can, in some approaches, be driven by microwave pulses. The atoms in optical traps are generally too close together for a microwave pulse to be focused on a single atom, but microwave pulses can drive transitions between the states for a plurality of atoms (which may include all of the neutral atoms 120, or a portion thereof). In other approaches, a transition between the |0 [symbol] and |1 [symbol] states of a single atom (or a plurality of atoms) can be driven optically by driving Raman transitions. In the example of FIG. 1, the optional Raman system 151 is configured to be operated to drive such transitions between the |0 [symbol] and |1 [symbol] states.

According to some embodiments, the optional Raman system 151 is configured to operate two phase-locked lasers with a frequency difference equal to the frequency difference between the |0 [symbol] and |1 [symbol] states, Ω₀₁. In this approach, the computational basis states |0 [symbol] and |1 [symbol] are effectively coupled via excitation to a higher energy state. Such lasers generated by the Raman system 151 may be focused on one or more neutral atoms as desired, for instance by operating one or more AOMs and/or AODs.

In some embodiments, the Raman system 151 is configured to direct a global Raman beam onto all (or at least a plurality of) the neutral atoms 120, and is additionally configured to direct a secondary Raman beam onto one or more neutral atoms as desired, such that the |0 [symbol] and |1 [symbol] states in a given neutral atom are coupled only when both Raman beams are directed onto the atom. By activating and deactivating (or adjusting the direction of) the secondary Raman beam onto a neutral atom, the coupling may be turned on and off. In some cases, both Raman beams may be produced by the same laser, and arranged with suitable optical components to produce the separate beams.

In some embodiments, the optional microwave system 153 is configured to direct a global microwave pulse onto all (or at least a plurality of) the neutral atoms 120, and a source of electromagnetic radiation (e.g., Raman system 151, Rydberg system 152 or otherwise) is configured to direct a beam, such as a Stark shifting beam, onto one or more neutral atoms as desired, such that the |0 [symbol] and |1 [symbol] states are coupled for an atom only when the microwave pulse and the beam are both directed onto the atom.

In some embodiments, the microwave system 153 and the Rydberg system 152 (or a part thereof) may be configured to drive single-qubit operations of the neutral atoms 120. In particular, the microwave system 153 may be operated to perform one type of single-qubit operation on all, or on a large number of the neutral atoms 120, and another source of electromagnetic radiation (e.g., Rydberg system 152 or a part thereof) may, at other times, drive another type of single-qubit operation of individual neutral atoms. For instance, in some embodiments the microwave system 153 is configured to perform global qubit rotations around equatorial axes in the Bloch sphere, and the Rydberg system 152 is configured to direct a beam onto one or more individual qubits to perform rotations around the Z axis in the Bloch sphere. By performing some ordered combination of either or both of these two types of operations, an arbitrary single-qubit gate on any individual neutral atom can be realized. As described below, the Rydberg system 152 may be configured to direct laser light at two different wavelengths onto a neutral atom to drive transitions between the |1 [symbol] and |r [symbol] states. In some cases, the rotations around the Z axis on single qubits may be performed by directing laser light having one of the two different wavelengths onto a neutral atom.

In the illustrative example of FIGS. 2A-2E, the optional Raman system 151 is not included, and single qubit gates are performed using the above-described approach of operating the microwave system 153 to perform one type of single-qubit operation on all, or on a large number of the neutral atoms 120, and operating the Rydberg system 152 or a part thereof to drive another type of single-qubit operation of individual neutral atoms.

In some embodiments, the Raman system 151 is configured to produce a frequency-modulated laser beam that is modulated to produce low-noise sidebands at the frequency difference between the |0 [symbol] and |1 [symbol] states, and subsequently passed through a dispersive element, thereby producing an amplitude-modulated beam that couples the two states.

In some embodiments, the Raman system 151 is configured to produce a global pulse that couples the |0 [symbol] and |1 [symbol] states for the purposes of applying the same operation to all of the neutral atoms. In such configurations, the Raman system 151 may also be configured in any one or more of the above ways to couple the |0 [symbol] and |1 [symbol] states in individual atoms.

According to some embodiments, the Raman system 151 may comprise one or more AWGs configured to be operated in conjunction with a laser source to shape pulses of Raman beams, and/or to configure pulses through in-phase and quadrature (“IQ”) control of the source.

In the example of FIG. 1, transitions between the |1 [symbol] and |r [symbol] states, which are for instance relied upon when performing entangling gates, are controlled by Rydberg system 152. In some embodiments, the Rydberg system 152 is configured to direct laser light at two different wavelengths onto one or more neutral atoms to couple the |1 [symbol] and |r [symbol] states. For example, the Rydberg system 152 may be configured to direct a bichromatic laser beam onto one or more neutral atoms to couple the |1 [symbol] and |r [symbol] states. As one example, for rubidium-87 atoms, the Rydberg system 152 may be configured to direct a bichromatic laser beam comprising 420 nm light and 1013 nm light onto one or more neutral atoms.

In some embodiments, the Rydberg system 152 is configured to direct laser light at one frequency onto all (or at least a plurality of) the neutral atoms 120, and is additionally configured to direct a secondary Rydberg beam onto one or more neutral atoms as desired, wherein activating and deactivating the secondary Rydberg beam turns the coupling between the |1 [symbol] and |r [symbol] states on and off. As one example, for rubidium-87 atoms, the Rydberg system 152 may be configured to direct a 1013 nm laser beam onto all of the neutral atoms, and to selectively direct pulses of a secondary laser beam at 420 nm onto one or more neutral atoms. The laser light directed onto all (or a plurality of) the neutral atoms may also be activated and deactivated over the time period of one or more operations, with the secondary Rydberg beam providing finer timing control over activation and deactivation of the coupling (e.g., the 1013 nm laser beam is directed onto all the neutral atoms for a time period in which one or more Rydberg excitations are performed, and during that period, the secondary Rydberg beam is turned on and off several times).

The Rydberg system 152 may be operated to direct any of the above laser beams onto neutral atoms at least in part by operating one or more AOMs and/or AODs to address individual atoms, pairs of atoms, or other groups of atoms.

According to some embodiments, one or more of the neutral atoms may be moved between traps in between quantum operations to ensure arbitrary connectivity between the neutral atoms. Such movement may be performed by operating the movement system 132 as described above in relation to FIG. 2C.

Subsequent to any number of manipulations of any number of the neutral atoms by the Rydberg system 152 and/or microwave system 153 as shown in FIG. 2D, the quantum information processor 100 may be operated to measure states of the neutral atoms with respect to the computational basis states |0 [symbol] and |1 [symbol] .

In some embodiments, the quantum information processor 100 may be configured to eject neutral atoms from the traps conditionally based on their state, and operate the readout system 141 and detector 142 to detect the remaining neutral atoms, thereby measuring the state of each of the neutral atoms. For instance, the quantum information processor 100 may be configured to eject neutral atoms from the traps when the neutral atoms are in the |1 [symbol] state and to retain the neutral atoms in the traps otherwise, then to detect in which traps neutral atoms remain. The detected remaining atoms after ejection of the other neutral atoms in this example may be determined to have been measured in the |0 [symbol] state. Such a process may also be performed in which neutral atoms are ejected conditionally on being in the |0 [symbol] state, thereby retaining neutral atoms in the |1 [symbol] state. In some embodiments, the trap system 131 may be operated during such a process to adjust the depth of the potential wells of the traps (e.g., to make the traps deeper).

According to some embodiments, the quantum information processor 100 may operate Raman system 151 and/or Rydberg system 152 to direct a resonant laser pulse that “blows away” atoms in either of the states |0 [symbol] or |1 [symbol] . In the example of FIG. 1 and FIG. 2E, the readout system 141 is configured to illuminate the neutral atoms 120 with an imaging beam subsequent to directing a resonant laser pulse to blow away atoms in either of the states |0 [symbol] or |1 [symbol] . The detector 142 may be configured and operated as described above to detect locations at which fluorescence light was produced.

In some embodiments, the quantum information processor 100 may be configured to perform non-destructive readout of the neutral atoms 120 by operating the readout system 141 and detector 142 to measure the state of each of the neutral atoms. In particular, the readout system 141 may be configured to illuminate the neutral atoms 120 with an imaging beam that causes the neutral atoms to fluoresce in different ways depending on their state. For instance, the imaging beam may cause only atoms in one of the states to fluoresce, or may cause atoms in one state to fluoresce in a different way (e.g., at a different intensity or at a different wavelength) from atoms in the other state. The detector 142 may be configured and operated as described above to detect fluorescence produced from the neutral atoms in this manner.

According to some embodiments, the quantum information processor 100 may include a variety of hardware and optical elements for directing, transmitting, modifying, focusing, dividing, modulating, and amplifying generated light fields to various shapes, sizes, profiles, orientations, polarizations, and intensities, as well as any other desirable properties. Some illustrative optical elements such as SLMs, AODs and AOMs have been described above. The quantum information processor 100 may also include other optical elements, such as various beam splitters, beam shapers, shapers, diffractive elements, refractive elements, gratings, mirrors, polarizers, modulators and so forth. While particular examples of operating hardware and optical elements are provided above with respect to particular elements of quantum information processor 100 shown in FIG. 1, it will be appreciated that multiple elements in FIG. 1 may share the same hardware and/or optical elements, and there is no requirement that such hardware and optical elements are separated into distinct units as shown in FIG. 1. For instance, the same SLM or AOD could be operated by multiple ones of the systems shown in FIG. 1 (e.g., the same AOD could be operated by the trap system 131 and by the Raman system 151).

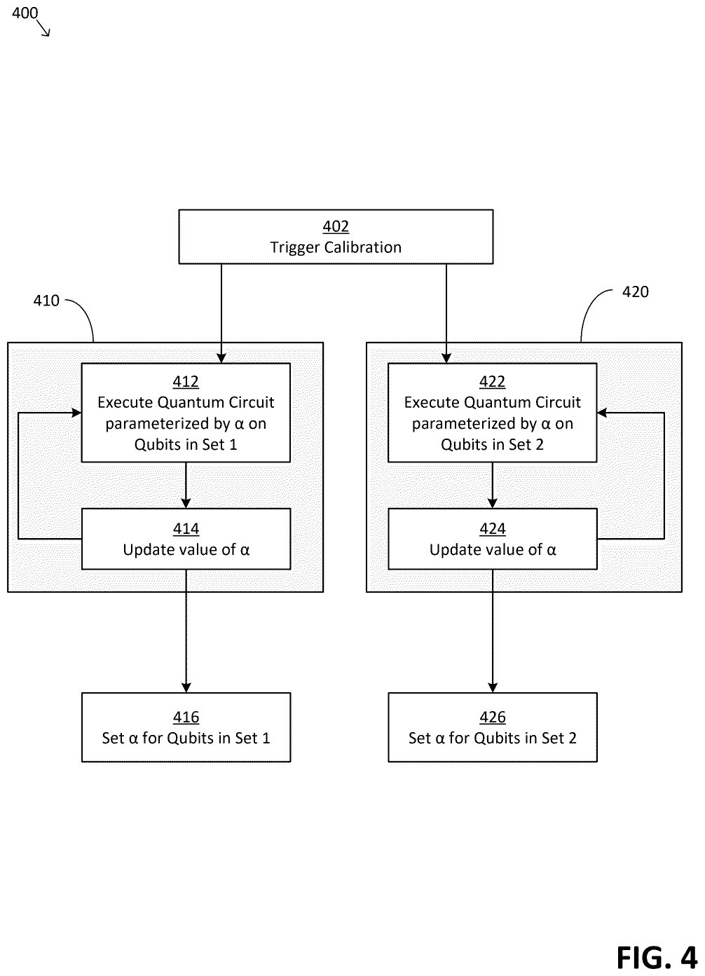

FIG. 4 is a flowchart of a method of calibrating control parameters of a quantum information processor, according to some embodiments. Having described the structure and operation of an illustrative quantum information processor 100 in FIG. 1, it will be clear that such a system operates based on numerous control parameters. For instance, to manipulate a neutral atom to perform a desired single-qubit gate in quantum information processor 100, the Raman system 151 may be operated with a frequency, duration, intensity and/or phase selected to execute the desired gate, and in general a calibrated value of each of these control parameters may vary across the neutral atoms in the traps. While such variation may be relatively small, the precision necessary to successfully operate the quantum information processor may mean that even minor variations in a control parameter may dramatically reduce the fidelity of operations. Other illustrative control parameters that may vary in quantum information processor 100 across the neutral atoms, and/or may vary between pairs and/or larger groups of the neutral atoms may include: an optical power produced by an SLM, AOD or AOM; a detuning Δ, drive frequency, or duration of a Rydberg pulse; a relative phase and/or timing of different operations performed as part of a quantum gate; a signal profile produced by an SLM or an AWG; a waveform profile produced by an AWG; a magnetic field intensity; and/or a frequency, phase and/or intensity of a signal provided to an AOD or AOM.

As described above, concurrently executing a quantum circuit parameterized by a control parameter on a plurality of sets of qubits may provide for a more efficient calibration process when the sets of qubits are disjoint. Method 400 provides an illustrative example of such a process, and may be performed by a quantum information processor such as, but not limited to, quantum information processor 100 shown in FIG. 1. In the case of quantum information processor 100 performing method 400, the acts may be performed by the controller 110, which in part controls other aspects of the quantum information processor to perform the acts of method 400.

Method 400 begins in act 402, in which a triggering event causes the calibration process of method 400 to begin. Suitable triggers may include detecting that the current time and/or date matches a time and/or date at which calibration is scheduled to be performed, or detecting that a predetermined amount of time has elapsed since a prior calibration. Additionally, or alternatively, a trigger may be based upon a measurement by the quantum information processor, and act 402 may comprise determining that the measurement indicates that calibration is desirable. For instance, a particular measurement may be associated with a range of values that indicate a desirable level of calibration. When the measurement is determined to lie outside this range, the quantum information processor may trigger the calibration process in act 402 in response to this determination. In some embodiments, determining whether to trigger the calibration process in act 402 may be based upon multiple measurements made by the quantum information processor.

Irrespective of how the calibration process is triggered in act 402, acts 410 and 420 are subsequently performed in method 400. It is desirable that the acts 410 and 420 are performed at least partially overlapping in time with one another, so that a more efficient calibration process may be realized. It may be desirable that these acts start at the same time, or approximately the same time, although this is not a requirement. Act 410 includes execution in act 412 of a quantum circuit, on a first set of qubits, where the quantum circuit is parameterized by a control parameter α, followed by updating the value of a in act 414. Acts 412 and 414 are repeated a plurality of times within act 410. Similarly, act 420 includes execution in act 422 of a quantum circuit, on a second set of qubits, where the quantum circuit is parameterized by the control parameter α, followed by updating the value of a in act 424. Acts 422 and 424 are repeated a plurality of times in act 420. In some embodiments, the qubits of the first and second sets are neutral atom qubits such as those described above in relation to FIGS. 1 and 2A-2E.

As referred to herein, a “quantum circuit” is a time-ordered collection of one or more operations. A quantum circuit includes one or more quantum operations, and may also include one or more non-quantum operations. Also as referred to herein, executing a plurality of quantum circuits is referred to as executing a “sequence” of quantum circuits. In some cases, the same quantum circuit may be executed a plurality of times (albeit with different values of a control parameter), which may be referred to herein as a sequence of that quantum circuit.

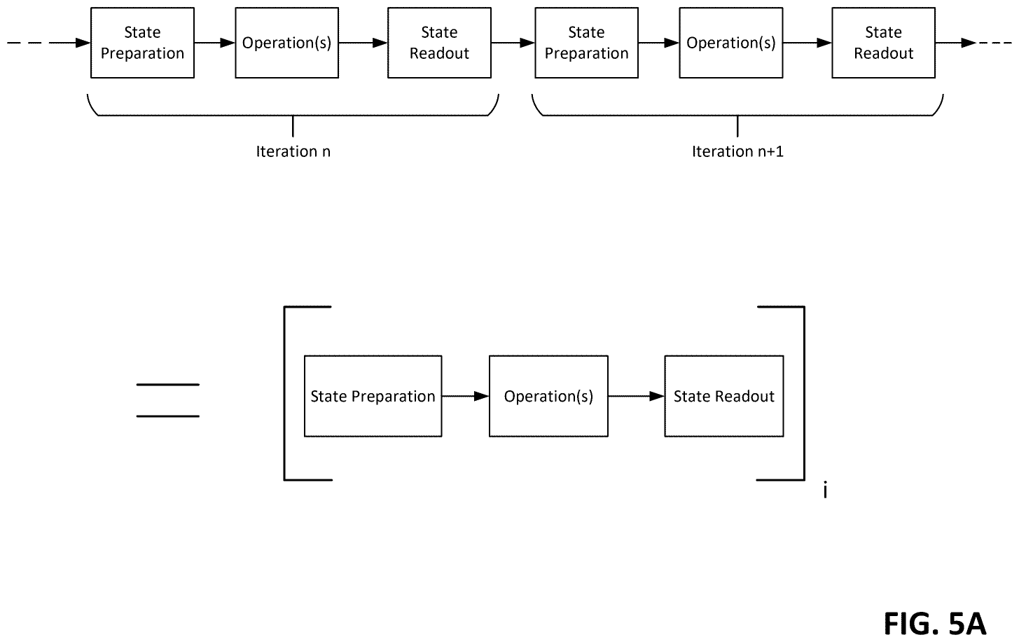

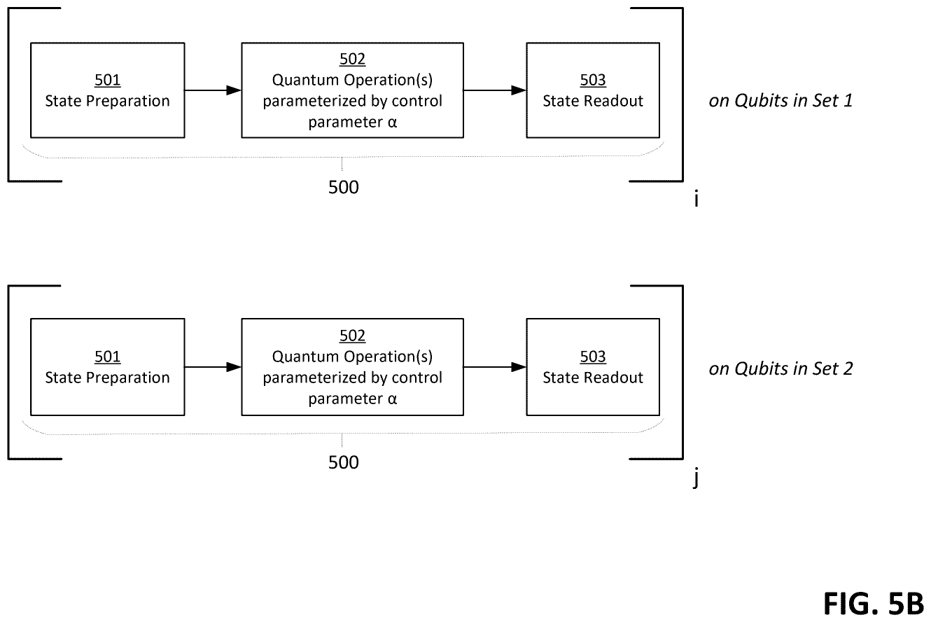

FIGS. 5A-5B depict an illustrative example of a sequence of a quantum circuit that is desirable for calibration, according to some embodiments. In the example of FIGS. 5A-5B, a quantum circuit that includes one or more state preparation operations, at least one quantum operation that is parameterized by a control parameter, and one or more readout operations, is executed repeatedly while varying the value of the control parameter, to calibrate the control parameter. As shown in FIG. 5A, a sequence of such a quantum circuit over a number of iterations may be depicted in the drawings with the operations of the quantum circuit surrounded by brackets and a label to illustrate repeated execution of the quantum circuit. In the example of FIG. 5A, a sequence of a quantum circuit that includes acts of state preparation, one or more operations, and state readout, is depicted. The label next to the brackets in this notation refers to the number of iterations in which the quantum circuit was executed (e.g., i times in the example of FIG. 5A).

Returning to FIG. 4, acts 412 and 422 may each comprise executing a quantum circuit that includes one or more state preparation operations, one or more operations that include at least one quantum operation, and one or more state readout operations, as shown in the example of FIG. 5A. In the example of FIG. 4, the same quantum circuit is executed in both acts 412 and 422, albeit with generally different values of the control parameter α that parameterizes the quantum circuit. In acts 414 and 424, the value of the control parameter α is updated.

The process of executing acts 410 and 420 concurrently may be represented as shown in FIG. 5B, in which the quantum circuit 500 is executed i times on a first set of qubits (i.e., over repeated instances of act 412), and the same quantum circuit 500 is also executed j times on a second set of qubits (i.e., over repeated instances of act 422). As noted above, execution of these two sequences of the quantum circuit may be performed concurrently, i.e., at least partially overlapping in time. In some cases, one sequence may be completed before the other sequence, and/or one of the sequences may begin execution before the other sequence begins execution. In the example of FIG. 5B, the quantum circuit 500 comprises one or more state preparation operations 501, one or more quantum operations 502 that are parameterized by the control parameter α, and one or more state readout operations 503. Additional operations may also be included in the quantum circuit 500, such as operations that are not parameterized by the control parameter α and that are performed between any of operations 501, 502 and 503, and/or in between different quantum operations 502. Between each iteration of the quantum circuit 500 shown in FIG. 5B, the quantum information processor performing method 400 may, in act 414 or 424, update, or otherwise adjust, the value of a so that one execution of the quantum circuit in the sequence with one value of a can be followed by an execution of the quantum circuit with a different value of a.

In the example of FIG. 5B, the one or more quantum operations 502 may include any manipulation(s) of a qubit, a pair of qubits, or a larger number of qubits. For instance, the one or more quantum operations 502 may include one or more single-qubit gates, one or more entangling gates (e.g., a two-qubit gate), one or more non-unitary operations (e.g., an excitation to a Rydberg state in a neutral atom qubit), or combinations thereof, in any suitable order. In the example of FIG. 4, a given quantum operation of the one or more quantum operations 502 may be performed simultaneously on all of the qubits in the set of qubits, sequentially on all of the qubits in the set of qubits (e.g., the operation is performed on the first qubit, then on the second qubit, etc.), or in some other manner (e.g., performed simultaneously on multiple qubits but less than all of the qubits in the set of qubits, then performed simultaneously on different multiple qubits, etc.).

According to some embodiments, the sequence of the quantum circuit 500 that is performed on the qubit(s) in set 1 may be temporally aligned in some way with the sequence of the quantum circuit 500 that is performed on the qubit(s) in set 2. In particular, in some approaches the state preparation act 501 in each sequence may be performed at the same time on the qubits in set 1 and in set 2. For instance, a global operation may be performed on qubits that includes the qubits in set 1 and set 2, which prepares the state of all of the qubits. Subsequently, the one or more quantum operations 502 may be performed on the qubits in set 1 and in set 2 as described above. Similarly, in some approaches the state readout act 503 in each sequence may be performed at the same time on the qubits in set 1 and in set 2. For instance, a global operation may be performed on qubits that includes the qubits in set 1 and set 2, which determines the state of all of the qubits. In some embodiments, both the acts of state preparation 501 and state readout 503 may be performed on the qubits in set 1 and on the qubits in set 2 with the same operation. This approach may be more efficient that performing separate state preparation or state readout operations on separate sets of qubits.

According to some embodiments, the one or more quantum operations 502 may comprise executing the same quantum operation a plurality of times in a row. In some cases, executing the same quantum operation a plurality of times in a row within act 412 or 422 (that is, within a given single execution of the quantum circuit 500) may improve the sensitivity of method 400 in detecting whether the control parameter is sufficiently calibrated. For example, when a quantum operation is expected to have the same initial and final states, executing this quantum operation a plurality of times in a row may produce a state that more readily deviates from the expected final state when the control parameter is not sufficiently calibrated, compared with the approach of executing the quantum operation only once.

As described above, a control parameter, such as the control parameter α, may refer to any parameter that has some relationship with a quantum information processor's operation and/or performance. As also described above, control parameters may include physical properties of an output of a component of the quantum information processor, hardware settings, non-physical parameters, or proxies for another parameter.

In some embodiments, acts 414 and 424 may each determine a new value of the control parameter α based on one or more results of one or more measurements made within the quantum circuit 500 (e.g., as part of the one or more state readout operations 503). For instance, a measurement made as part of executing the quantum circuit 500 may be indicative of how close the value of a used during that execution of the quantum circuit is to proper calibration. As one example, a quantum circuit may comprise one or more quantum operations, parameterized by α, that manipulate a qubit so that, when α is properly calibrated, the probability of measuring the qubit to be in a particular state (e.g., the |1 [symbol] state) is maximized. Measurements of the state of the qubit, after executing the one or more quantum operations therefore provide an indication of how close α is to being properly calibrated.

In some iterations of act 410 (420), act 414 (424) may not adjust the value of, because multiple executions of the quantum circuit 500 with the same value of a, and subsequent measurements thereof, are desirable to determine proper calibration. For instance, if a desired result is based on a probability of measuring a particular state, the state may be measured multiple times to estimate the probability. In some cases, therefore, act 410 (420) may comprise multiple instances of act 412 (422) in which the quantum circuit 500 is executed with the same value of a, followed by an adjustment to the value of a, following by multiple instances of act 412 (422) in which the quantum circuit is executed with the new value of a, etc. As such, it will be appreciated that updating the value of a in acts 414 and 424 may not necessarily comprise changing the value of a.

According to some embodiments, act 414 and/or act 424 may comprise calculating a loss function, cost function, or some other measure indicative of how close α is to being properly calibrated, and calculating or otherwise selecting a new value of a based on the measure. Such a measure may be determined based in part on one or more measurements of one or more qubits subsequent to executing the quantum circuit 500. In some cases, a new value of a may be selected by performing a suitable optimization technique.

According to some embodiments, acts 410 and 420 may proceed to acts 416 and 426, respectively, when it is determined that the control parameter α has been calibrated to a desired degree. For instance, wherein acts 410 or 420 comprise calculating some measure indicative of how close α is to being properly calibrated (e.g., a loss function or cost function), act 410 and/or act 420 may comprise determining whether this measure is below a threshold, and proceeding to act 416 or act 426, respectively, when it is determined that the measure is below the threshold.

In acts 416 and 426, values of a that were determined in act 410 or 420, respectively, to represent calibrated values of a, are stored or otherwise associated with the first set of qubits. Calibrated values of a may relate to a single qubit in a given set of qubits, and/or may relate to a particular group of two or more qubits in the set of qubits. As such, there may be multiple calibrated values of a determined for a given set of qubits. In some cases, a is a control parameter that relates to a single qubit, and the first set of qubits consists of a single qubit, in which case there is a single value of a determined during calibration for the first set of qubits. In other cases, a is a control parameter that relates to some aspect of a two-qubit gate, and the first set of qubits consists of two qubits, in which case there may be a single value of a calibrated for the two-qubit gate for this pair of qubits. For example, if the first set of qubits consists of four qubits, there may be between one and six calibrated values of a for the first set of qubits, representing the possible values that may be associated with any given pair of those four qubits (e.g., all four qubits may be calibrated to have a common value of a for any two-qubit gate perform among the qubits, or each individual pair of the four qubits may be calibrated to have a distinct value of a for a two-qubit gate involving that pair of qubits, or some intermediate arrangement may also be envisioned). In yet further cases, a is a control parameter that relates to some aspect of a three-qubit gate, or a gate that involves four or more qubits.

Irrespective of the number of values of a that are determined in act 410 or in act 420, in some embodiments these values may be stored in a suitable computer readable storage medium (e.g., a memory) in acts 416 and 426, respectively. In some embodiments, acts 416 and 426 comprise adjusting a hardware setting that relates to the control parameter α. For example, if the control parameter α is a frequency, acts 416 and 426 may comprise adjusting a setting of an AOM to produce the calibrated frequency.

In some embodiments, method 400 comprises additional sequences of the quantum circuit 500 executed on other sets of qubits, such as a third set of qubits, a fourth set of qubits, etc. As such, each of the two branches of method 400 that, in the example of FIG. 4, include acts 410 and 420, may be duplicated as many times as desired, so that the quantum circuit 500 may be executed concurrently on any arbitrary number of sets of qubits. In some embodiments, the sets of qubits on which the quantum circuit is executed may include all of the qubits in the quantum information processor (i.e., every qubit in the quantum information processor is present in one of the sets of qubits). The extent to which this is feasible may depend on the particular implementation of the quantum information processor.

In some embodiments, the quantum circuit executed in acts 412 and 422 is parameterized by multiple control parameters. In this case, acts 414 and 424 may comprise updating the values of each of the multiple control parameters, and acts 416 and 426 may comprise setting values of each of the multiple control parameters for the qubits in set 1 and set 2. For example, the quantum circuit may be parameterized by a vector quantity which has multiple components. Method 400 may be readily extended to such use cases, such that multiple control parameters are calibrated by performing method 400.

According to some embodiments, one of the advantages of calibrating a control parameter by performing method 400 may be that a process of configuring the quantum information processor to perform method 400, and thereby calibrate the control parameter for multiple sets of qubits, may only need to be performed once. For example, operating quantum information processor 100 shown in FIG. 1 to perform calibration operations for one set of qubits may comprise the controller 110, and/or any other computing device, generating a set of instructions to be executed by the control electronics 130 and readout electronics 140, which operate various devices in a precisely timed set of operations. Generating such instructions can take a significant amount of time, and therefore generating instructions to calibrate two sets of qubits at the same time may be more efficient than generating instructions to calibrate one set of qubits, performing the calibration for this set of qubits, then generating instructions to calibrate another set of qubits, then performing this calibration for this set of qubits.

According to some embodiments, the values of the control parameter α used in successive executions of the quantum circuit in acts 412 and 422 are not determined prior to beginning act 402, or at least prior to the initial executions of acts 410 or 420. That is, the values of a selected in acts 414 and 424 may be selected dynamically while performing method 400. In some embodiments, acts 414 and 424 may be performed by hardware controllers that are capable of quickly and dynamically updating instructions to be executed by the control electronics 130 and readout electronics 140. Such hardware controllers may be, or may be part of, controller 110, control electronics 130 and/or readout electronics 140.

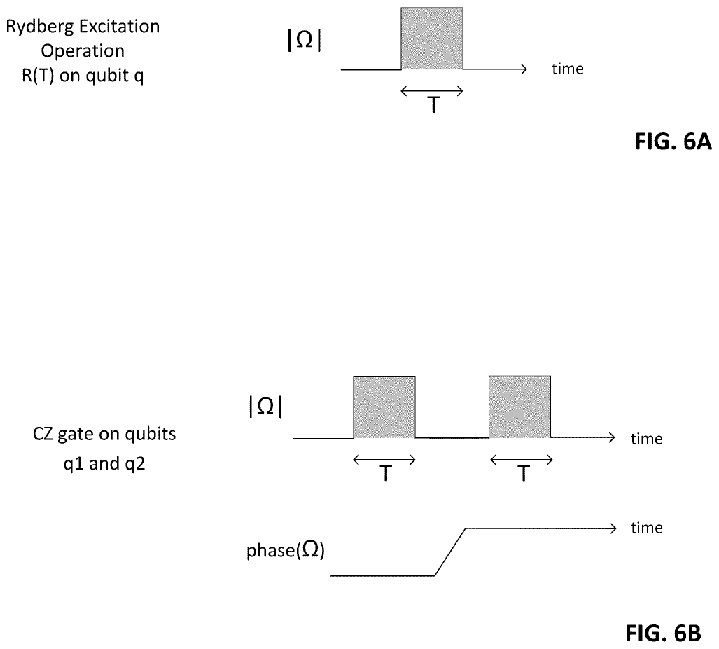

As one illustrative example of performing method 400, consider the quantum operation of performing a Rydberg excitation of a pair of neutral atoms. The Rydberg excitation couples the |1 [symbol] state and the |r [symbol] state, and can be performed for instance by directing a Rydberg pulse having a Rabi frequency 12 (representing the coupling strength) onto the pair of atoms for a duration T (e.g., by operating Rydberg system 152 in the example of FIG. 1). This pulse is depicted in FIG. 6A, and is a building block of a two-qubit gate, the CZ gate, which is depicted in FIG. 6B and described further below. In the example of FIG. 6A, the detuning Δ of the Rydberg pulse may be set to zero so that the Rydberg excitations are resonant Rabi oscillation pulses.

In the example of FIG. 6A, to calibrate the value of the duration T for a given pair of neutral atoms, the method of FIG. 4, as depicted in FIGS. 5A and 5B, may be performed in which the control parameter α being calibrated is the duration T. The quantum circuit 500 in this example may comprise steps of preparing the states of two qubits, then applying the Rydberg excitation pulse shown in FIG. 6A to both neutral atoms, then measuring a state of one or both atoms. The measurement(s) may, as described above, indicate how well calibrated T was during that execution of the quantum circuit, and a new value of T may be selected based on the measurement, and so forth, as per method 400 until it is determined that T is sufficiently calibrated. As in the example of FIG. 4, execution of a sequence of this quantum circuit may be performed for a first set of neutral atoms, being a first pair of neutral atoms, to determine a calibrated value of T for that pair of atoms (e.g., in act 410), and may be concurrently performed for a second set of neutral atoms, being a second pair of neutral atoms, to determine a calibrated value of T for that pair of atoms (e.g., in act 420). Additional executions of the quantum circuit may be performed for additional pairs, as described above.

In some implementations, the quantum circuit executed to calibrate the duration T for a given pair of neutral atoms by utilizing the Rydberg excitation pulse shown in FIG. 6A, may comprise state preparation operations that arrange the two atoms in the |11 [symbol] state. When subsequently applying the Rydberg excitation pulse to both of the atoms for a duration T, the atoms couple to a state W=(|1r [symbol] +|r1 [symbol] )/\sqrt{2}. Subsequently, the state of either or both atoms may be measured. When the duration Tis sufficiently calibrated, it may be expected that the two atoms has returned to the |11 [symbol] state. If the duration T is not sufficiently calibrated, there is a non-zero probability that one of the atoms will be in the |r [symbol] state; repeated measurements of the states of both atoms will therefore indicate whether the duration Tis sufficiently calibrated. As described above, some quantum circuits may comprise the same operation a plurality of times to be more sensitive to detecting that a control parameter is not sufficiently calibrated. In this example, for instance, the Rydberg excitation pulse shown in FIG. 6A may be applied to the atoms a plurality of times (e.g., 20 or more times) in a row. When the duration T is not sufficiently calibrated, the probability that one of the atoms will be in the |r [symbol] state will in this approach be higher compared with an approach in which the Rydberg pulse is only applied once.

In the example of FIG. 6A, performing this illustrative quantum circuit may leave atoms in the Rydberg state, which could cause unwanted blockade interactions among the neutral atoms. As a result, this illustrative quantum circuit may include one or more operations that eject neutral atoms in the Rydberg state, or that manipulate atoms in the Rydberg state to one of the computational basis states (or some other non-Rydberg state).

As another example of a quantum circuit that may be executed within method 400, FIG. 6B depicts a CZ gate, which includes two Rydberg excitation pulses at a frequency Ω, that are both applied to a pair of neutral atoms, wherein each pulse is applied a duration T. In addition, the phase of the Rydberg excitation signal is adjusted between the pulses, as shown. As shown by FIG. 3A, a Rydberg excitation signal at the Rabi frequency Ω is detuned from the |1 [symbol] ↔|r [symbol] transition by a finite detuning Δ. The duration T may have been previously calibrated for the pair of atoms (e.g., via the process described above with respect to the example of FIG. 6A), and therefore a quantum circuit to calibrate the detuning Δ may be executed in method 400. An alternative way to perform the CZ gate with quantum information processor 100 is to apply a single one of the two Rydberg excitation pulses shown in FIG. 6B, with a phase that is sinusoidally varied during the pulse.

In particular, a quantum circuit may be configured to prepare states of the two neutral atoms in any of the |00 [symbol] , |01 [symbol] , |10 [symbol] or |11 [symbol] states, to apply a pair of Rydberg excitation pulses to the two neutral atoms as shown in FIG. 6B, and to measure a state of either or both of the neutral atoms. The control parameter Δ may be adjusted between executions of the quantum circuit until the measurement results align (or until the results are optimally aligned) with results that should be produced by the CZ gate. That is, if the initial states are any of |00 [symbol] , |01 [symbol] , |10 [symbol] , the initial and final states are the same, but if the initial state is |11 [symbol] , the final state is −|11 [symbol] (the phase of one of the neutral atoms is flipped). Various different initial states may be combined with various different measurements to determine how closely the performance of the quantum circuit aligns with that of the CZ gate. As with the example of FIG. 6A, multiple sequences of this quantum circuit may be executed concurrently, on disjoint sets of neutral atoms, to calibrate the control parameter Δ for one or more pairs of neutral atoms in each set.

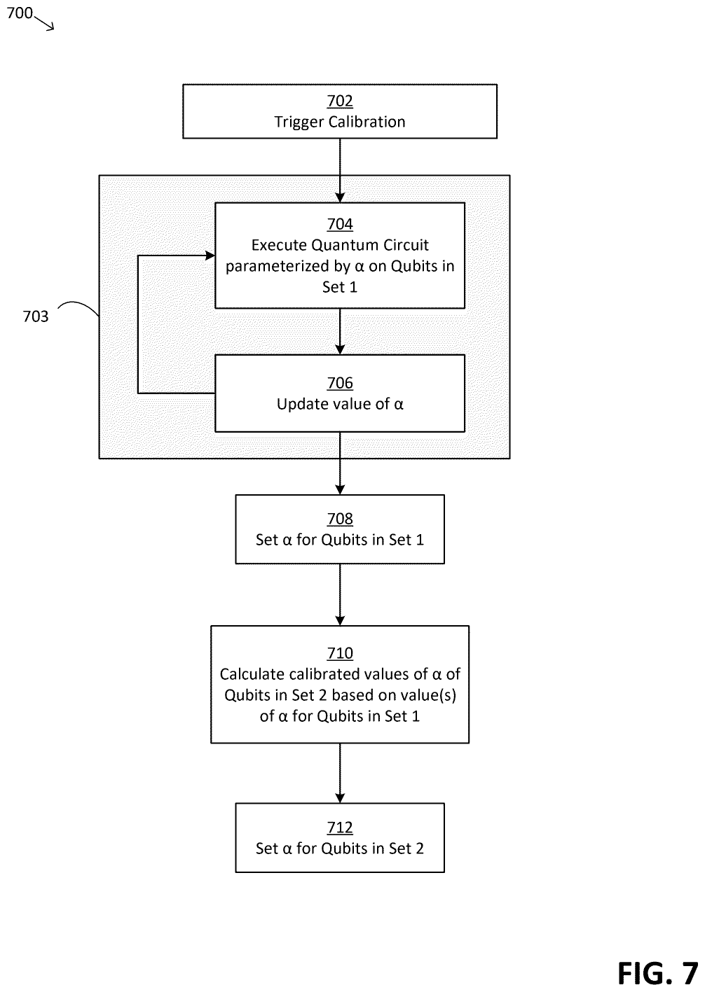

FIG. 7 is a flowchart of a method of calibrating control parameters of a quantum information processor, according to some embodiments. As described above, calibrating the value of a control parameter on a first set of qubits by concurrently executing a quantum circuit parameterized by the control parameter on the first set of qubits, and then extending the calibrated value(s) of the control parameter to a second set of qubits, may provide for a more efficient calibration process. Method 700 provides an illustrative example of such a process, and may be performed by a quantum information processor such as, but not limited to, quantum information processor 100 shown in FIG. 1. In the case of quantum information processor 100 performing method 700, the acts may be performed by the controller 110, which in part controls other aspects of the quantum information processor to perform the described acts, as described above.

Method 700 begins in act 702, in which some triggering event causes the calibration process of method 700 to begin. Any of the techniques described above with respect to act 402 in method 400 may be performed in act 702.

In the example of FIG. 7, act 703 is performed subsequent to act 702, and includes execution in act 704 of a quantum circuit, on a first set of qubits, where the quantum circuit is parameterized by a control parameter α, followed by an adjustment of the value of a in act 706. Act 703 may be performed in any of the ways described above in relation to acts 410 and 420 in method 400. For example, act 704 may comprise executing a quantum circuit that includes acts of state preparation, one or more operations, and state readout, and act 706 may comprise calculating a measure indicative of how close α is to being properly calibrated, and calculating or otherwise selecting a new value of α based on the measure. Moreover, act 703 may comprise determining that the value of α is sufficiently calibrated before proceeding to act 708.

In act 708, values of α that were determined in act 703 to represent calibrated values of a, are stored or otherwise associated with the first set of qubits. Any of the techniques described above with respect to acts 416 and 426 in method 400 may be performed in act 708.

In act 710, calibrated values of a are determined for one or more qubits in a second set of qubits based on the calibrated values of a determined for the first set of qubits. Calibrated values of α for the second set of qubits may be calculated by extending (e.g., estimating by extrapolating and/or interpolating) the calibrated values of α determined for the first set of qubits in act 703. For example, the calibrated values of α for the second set of qubits may be calculated through linear extrapolation, polynomial extrapolation, conic extrapolation, linear interpolation, polynomial interpolation, spline interpolation, linear regression, or combinations thereof. In some embodiments, the calibrated values of α are determined for one or more qubits in the second set of qubits based at least in part on some property that is correlated between the first and second sets of qubits. Suitable correlated properties may include spatial location or some other measure of relative position within a register of qubits.

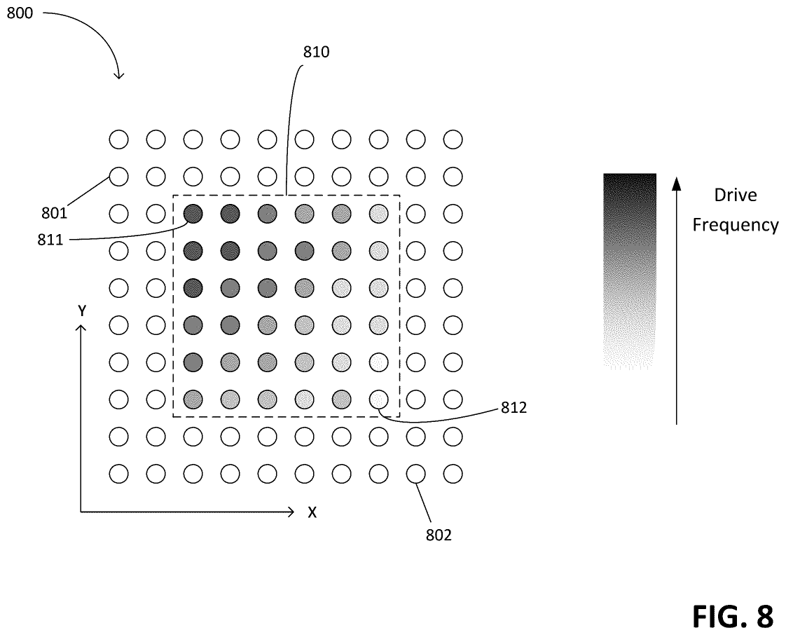

To illustrate one example of performing method 700, FIG. 8 depicts an array of neutral atoms 800, that includes neutral atoms 810 for which the value of a drive frequency control parameter has been previously calibrated for each atom (e.g., by performing act 703). The drive frequencies may for instance be an AOD operational drive frequency associated with each atom. In the example of FIG. 8, the magnitude of the calibrated drive frequency value is depicted using shades of grey, with a darker color indicating a comparatively high drive frequency and a light color indicating a comparatively low drive frequency. In practice the range of calibrated drive frequencies may be small compared with the magnitude of the drive frequency. As may be seen in FIG. 8, the calibrated drive frequency values for the first set of neutral atoms 810 is roughly correlated spatially, with the drive frequency increasing generally in the +Y and −X directions.

With respect to method 700, act 703 may be performed for any suitable quantum circuit that is parameterized by the drive frequency and for which one or more measurements produce expected results when the drive frequency is sufficiently calibrated. Subsequently, the calibrated values of the drive frequency for the neutral atoms 810 may be extended to any of the other neutral atoms in array 800. For instance, through extrapolation (e.g., linear extrapolation) a calibrated value of the drive frequency for neutral atom 801 may be determined to be higher than the previously determined calibrated value for neutral atom 811. Similarly, through extrapolation a calibrated value of the drive frequency for neutral atom 802 may be determined to be lower than the previously determined calibrated value for neutral atom 812.

As an alternative to method 700, in some embodiments the value of a control parameter may be extended within the same set of qubits. In this approach, acts 702, 704, and 706 are performed as described above to produce a set of measurements that are a function of the value of the control parameter α. The expected measurements may be then extended to other values of α for the same set of qubits. For example, a control parameter α may be an amount of time elapsed between state preparation and the execution of one or more quantum operations. Act 704 may be performed multiple times with different values of α to determine how a particular measurement result or results varies with α. The expected measurement result(s) that would be expected for other values of α for the same set of qubits may thereby be determined through extrapolation and/or interpolation.

Returning to method 700, in act 712 values of a that were determined in act 710 to represent calibrated values of α are stored or otherwise associated with the second set of qubits. Any of the techniques described above with respect to acts 416 and 426 in method 400 may be performed in act 712.

It may be appreciated that method 700 may be adapted so that act 703 is performed multiple times concurrently to determine calibrated values of α for each of a plurality of sets of qubits. For instance, once a calibration process is triggered in act 702, a sequence of a quantum circuit parameterized by α may be executed for a plurality of sets of qubits, where each sequence is executed concurrently. In the example of FIG. 8, for example, method 700 may comprise executing a sequence of a quantum circuit for each of the neutral atoms 810 individually (that is, executing 36 sequences of the quantum circuit in which each set of qubits includes a single one of the neutral atoms). As a result, each execution of a sequence of the quantum circuit may determine one value of α for the associated neutral atom. In addition, in some cases the quantum circuit executed in act 704 of method 700 may, in the example of FIG. 8, be parameterized by two different drive frequencies (e.g., representing the drive frequencies of a pair of crossed AODs that, when calibrated, will properly direct a beam onto a particular neutral atom).

In addition to adapting method 700 in this manner, acts 703, 708, 710 and 712 may also be performed multiple times concurrently. In particular, while a sequence of a first quantum circuit is executed on a first set of qubits to optimize a parameter α that parameterizes the first quantum circuit, a sequence of a second quantum circuit is executed on a second set of qubits to optimize a parameter β that parameterizes the second quantum circuit. In this approach, the first set of qubits and the second set of qubits may be disjoint, and/or the parameters α and β may exhibit no correlation in their values.

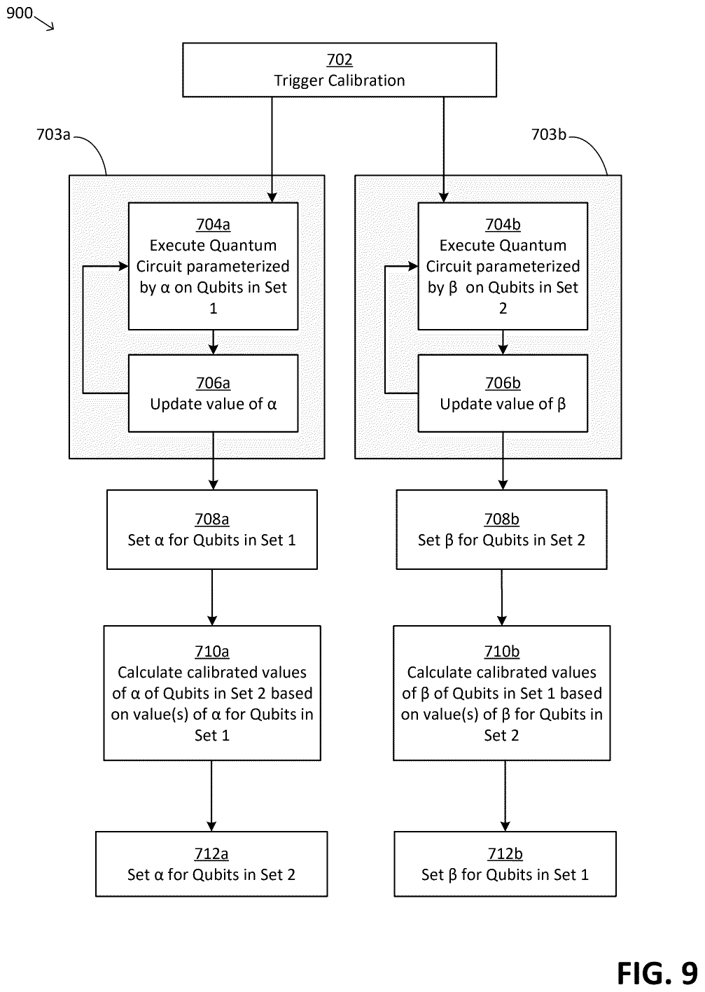

An example of this process is provided as method 900 shown in FIG. 9, which includes act 702 from method 700, and additionally includes two instances of each of acts 703, 704, 706, 708, 710 and 712, labeled with suffixes ‘a’ and ‘b’ in FIG. 9. Any techniques described above with respect to acts 703, 704, 706, 708, 710 and 712 may be performed with respect to acts 703a, 704a, 706a, 708a, 710a and 712a, respectively; and any techniques described above with respect to acts 703, 704, 706, 708, 710 and 712 may be performed with respect to acts 703b, 704b, 706b, 708b, 710b and 712b, respectively. Method 900 may be performed by a quantum information processor such as, but not limited to, quantum information processor 100 shown in FIG. 1.

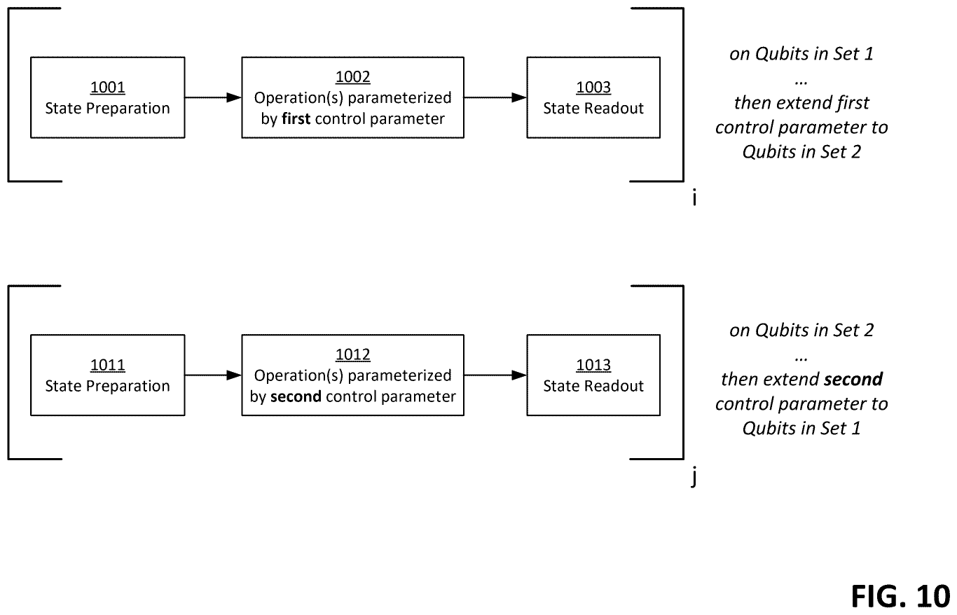

According to some embodiments, method 900 may allow qubits to be calibrated for multiple parameters α and β from the concurrent execution of multiple sequences of quantum circuits. This process is also represented in FIG. 10, which utilizes the notation introduced in FIG. 5A. In particular, in the example of FIG. 10, a sequence of a first quantum circuit is executed, where the first quantum circuit includes one or more state preparation operations 1001, one or more operations 1002 parameterized by a first control parameter, and one or more state readout operations 1003; and concurrently a sequence of a second quantum circuit is executed, where the second quantum circuit includes one or more state preparation operations 1011, one or more operations 1012 parameterized by a second control parameter, and one or more state readout operations 1013.

It may be appreciated that method 900 may be extended so that acts 703a and 703b are each performed multiple times concurrently to determine calibrated values of α and β, respectively, for each of a plurality of sets of qubits. For instance, once a calibration process is triggered in act 702 in method 900, a plurality of sequences of a first quantum circuit parameterized by α may be executed concurrently for a first plurality of sets of qubits, and a plurality of sequences of a second quantum circuit parameterized by β may be executed concurrently for a second plurality of sets of qubits. Calibrated values of α may then be extended to sets of qubits other than the first plurality of sets of qubits (e.g., the second plurality of sets of qubits) and calibrated values of β may then be extended to sets of qubits other than the second plurality of sets of qubits (e.g., the first plurality of sets of qubits). In such an approach the first plurality of sets of qubits may be disjoint from the second plurality of sets of qubits.

As an example of this approach, the array of one hundred neutral atoms shown in FIG. 8 may be treated as one hundred disjoint sets of qubits with a single qubit in each set. A sequence of a first quantum circuit parameterized by α may be concurrently executed for each of fifty neutral atoms to calibrate α for those sets of qubits, and a sequence of a second quantum circuit parameterized by β may be concurrently executed for the remaining fifty neutral atoms to calibrate β for those sets of qubits. The sets of qubits to calibrate for α or β may be selected to be spatially diverse, for example by selecting fifty neutral atoms in a checkerboard pattern to calibrate for α, and by selecting the remaining fifty neutral atoms in a checkerboard pattern to calibrate for β. Subsequent to executing the sequences of the first and second quantum circuits, the calibrated values of α and β may be extended to the remaining neutral atoms, thereby calibrating α and β for all of the one hundred neutral atoms. If all the sequences of the first and second quantum circuits are executed concurrently, a highly efficient process for calibrating a large number of qubits for a plurality of control parameters may be realized.

As described above, although the above techniques were in part described with respect to a neutral atom quantum information processor, they may readily be also applied to other types of quantum information processor. For example, a quantum information processor comprising superconducting qubits may be operated to execute a sequence of quantum circuits and to calibrate various control parameters used in operation of such a quantum information processor. For instance, the techniques above may be used to calibrate various drive frequencies, such as the frequencies of microwave pulses, to control superconducting qubits.

As referred to herein, a “qubit” includes any multi-level quantum-mechanical system capable of being controlled by a quantum information processor. The quantum states of the qubit may for instance include electronic states, polarization states, vibrational states, rotational states, or spin states.

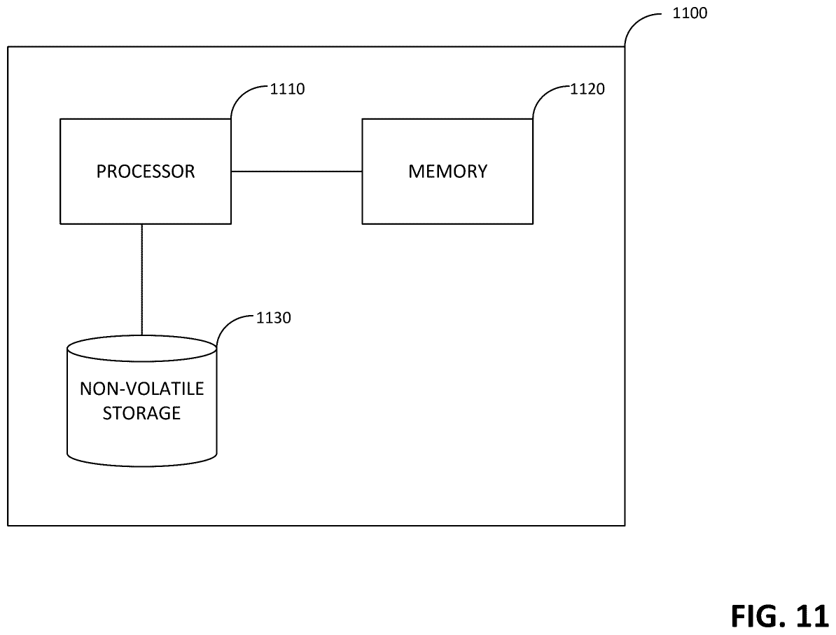

An illustrative implementation of a computer system 1100 that may be used to control aspects of a quantum information processor to perform any of the techniques described above is shown in FIG. 11. The computer system 1100 may include one or more processors 1110 and one or more non-transitory computer-readable storage media (e.g., memory 1120 and one or more non-volatile storage media 1130). The one or more processors 1110 may control writing data to and reading data from the memory 1120 and the one or more non-volatile storage media 1130 in any suitable manner, as the aspects of the disclosure described herein are not limited in this respect. To perform functionality and/or techniques described herein, the one or more processors 1110 may execute one or more instructions stored in one or more computer-readable storage media (e.g., the memory 1120, storage media, etc.), which may serve as non-transitory computer-readable storage media storing instructions for execution by the one or more processors 1110.

In connection with techniques described herein, code used to, for example, generate instructions to operate control electronics, operate readout electronics, etc. may be stored on one or more computer-readable storage media of computer system 1100. The one or more processors 1110 may execute any such code to perform any of the above-described techniques as described herein. Any other software, programs or instructions described herein may also be stored and executed by computer system 1100. It will be appreciated that computer code may be applied to any aspects of methods and techniques described herein. For example, computer code may be applied to optimize the value of a control parameter, to calculate extrapolated and/or interpolated values of a control parameter, etc.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art. For instance, aspects of the techniques described herein may be combined in any of the following ways:
Aspect 1. A method comprising: determining calibrated values of a first control parameter for each qubit of a plurality of qubits, the plurality of qubits including a first set of qubits and a second set of qubits disjoint from the first set of qubits, wherein determining the calibrated values of the first control parameter for each qubit of the plurality of qubits comprises: executing a first sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit; and concurrently with executing the first sequence of the quantum circuit on the first set of qubits, executing a second sequence of the quantum circuit on the second set of qubits using the quantum information processor, wherein the quantum circuit is executed with a plurality of different values of the first control parameter when executing the second sequence of the quantum circuit.
Aspect 2. The method of aspect 1, further comprising determining a value of a cost function subsequent to each execution of the first sequence of the quantum circuit, and updating a value of the first control parameter based on the determined value of the cost function.
Aspect 3. The method of aspect 1, wherein the plurality of qubits is a plurality of neutral atom qubits arranged in optical traps, and wherein executing the first sequence of the quantum circuit comprises operating an optical system to direct one or more laser beams onto qubits of the first set of qubits.
Aspect 4. The method of aspect 3, wherein the first control parameter for each qubit of the plurality of qubits is a hardware setting of the optical system arranged to direct the one or more laser beams onto the qubit.
Aspect 5. The method of aspect 3, wherein the first control parameter for each qubit of the plurality of qubits is a frequency or a duration of a laser pulse directed onto the qubit.
Aspect 6. The method of aspect 3, wherein executing the at least one quantum operation on a qubit of the first set of qubits comprises operating the optical system to apply a Rabi oscillation pulse to the qubit.
Aspect 7. The method of aspect 6, wherein the first control parameter is a frequency of the Rabi oscillation pulse.
Aspect 8. The method of aspect 6, wherein the first control parameter parameterizes a hardware setting of the optical system that controls a frequency of the one or more laser beams.
Aspect 9. The method of aspect 1, wherein executing the quantum circuit on the first set of qubits comprises: performing a state preparation operation on each qubit of the first set of qubits, which initializes a state of each qubit; performing the at least one quantum operation that is parameterized by the first control parameter on each qubit of the first set of qubits; and performing a readout operation that measures the state of each qubit of the first set of qubits subsequent to performing the at least one quantum operation that is parameterized by the first control parameter.
Aspect 10. The method of aspect 9, wherein the plurality of qubits is a plurality of neutral atom qubits, wherein performing the at least one quantum operation that is parameterized by the first control parameter on each qubit of the first set of qubits comprises, for each qubit of the first set of qubits, operating an optical system to direct a Rydberg excitation pulse onto the qubit, and wherein the first control parameter is a duration or a frequency of the Rydberg excitation pulse.
Aspect 11. The method of aspect 3, wherein executing the at least one quantum operation on a qubit of the first set of qubits comprises operating the optical system to apply a single qubit gate to the qubit.
Aspect 12. The method of aspect 3, wherein executing the at least one quantum operation on the first set of qubits comprises operating the optical system to apply plurality of two qubit gates to pairs of qubits of the first set of qubits.
Aspect 13. The method of aspect 1, wherein executing the first sequence of the quantum circuit on the first set of qubits comprises executing the quantum circuit on pairs of qubits of the first set of qubits.
Aspect 14. A method comprising: determining calibrated values of a first control parameter for each qubit of a first set of qubits, wherein determining the calibrated values of the first control parameter for each qubit of the first set of qubits comprises: executing a sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the sequence of the quantum circuit; and calculate calibrated values of the first control parameter for each qubit of a second set of qubits based on the determined calibrated values of the first control parameter for each qubit of the first set of qubits and based on at least one correlated property between the qubit of the second set of qubits and the first set of qubits.
Aspect 15. The method of aspect 14, further comprising determining a value of a cost function subsequent to each execution of the quantum circuit in the sequence, and updating a value of the first control parameter based on the determined value of the cost function.
Aspect 16. The method of aspect 14, wherein the at least one correlated property includes a relative spatial position between the qubit of the second set of qubits and the first set of qubits.
Aspect 17. The method of aspect 14, wherein calculating the calibrated values of the first control parameter for each qubit of the second set of qubits comprises extrapolating and/or interpolating one or more of the calibrated values of the first control parameter for each qubit of the first set of qubits.
Aspect 18. The method of aspect 14, wherein the plurality of qubits is a plurality of neutral atom qubits arranged in optical traps, and wherein executing the sequence of the quantum circuit comprises operating an optical system to direct one or more laser beams onto qubits of the first set of qubits.
Aspect 19. The method of aspect 18, wherein the first control parameter for each qubit of the first set of qubits is a frequency of the one or more laser beams directed onto the qubit.
Aspect 20. The method of aspect 14, wherein the quantum circuit is a first quantum circuit, and wherein the method further comprises: determining calibrated values of a second control parameter for each qubit of a third set of qubits, disjoint from the first set of qubits, wherein determining the calibrated values of the second control parameter for each qubit of the third set of qubits comprises, concurrently with executing the sequence of the first quantum circuit on the first set of qubits: executing a sequence of a second quantum circuit on the third set of qubits using the quantum information processor, wherein the second quantum circuit comprises one or more quantum operations including at least one quantum operation that is parameterized by the second control parameter, and wherein the second quantum circuit is executed with a plurality of different values of the second control parameter when executing the sequence of the second quantum circuit; and calculating calibrated values of the second control parameter for each qubit of the second set of qubits based on the determined calibrated values of the second control parameter for each qubit of the third set of qubits and based on at least one correlated property between the third set of qubits and the second set of qubits.
Aspect 21. A system comprising: an optical system configured to trap, and manipulate quantum states of, a plurality of neutral atom qubits, wherein operation of the optical system is controlled by at least a first control parameter; and at least one controller configured to: determine calibrated values of the first control parameter for each of the plurality of neutral atom qubits, the plurality of neutral atom qubits including a first set of neutral atom qubits and a second set of neutral atom qubits disjoint from the first set of neutral atom qubits, wherein determining the calibrated values of the first control parameter for each neutral atom qubit of the plurality of neutral atom qubits comprises: executing a first sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit; and concurrently with executing the first sequence of the quantum circuit on the first set of neutral atom qubits, executing a second sequence of the quantum circuit on the second set of neutral atom qubits at least in part by operating the optical system, wherein the quantum circuit is executed with a plurality of different values of the first control parameter when executing the second sequence of the quantum circuit.
Aspect 22. The system of aspect 21, wherein the at least one controller is configured to execute the first sequence of the quantum circuit on the first set of neutral atom qubits by operating the optical system to direct at least one Raman laser onto the first set of neutral atom qubits.
Aspect 23. The system of aspect 21, wherein the at least one controller is configured to execute the first sequence of the quantum circuit on the first set of neutral atom qubits by operating the optical system to direct light onto the first set of neutral atom qubits, and to subsequently observe fluorescence light produced by the first set of neutral atom qubits.
Aspect 24. The system of aspect 21, wherein the optical system comprises at least one laser and at least one spatial light modulator (SLM).
Aspect 25. The system of aspect 24, wherein the optical system further comprises at least one acousto-optic deflector and/or at least one acousto-optic modulator.
Aspect 26. The system of aspect 21, wherein the first control parameter is a hardware setting of the optical system.
Aspect 27. The system of aspect 21, wherein executing the at least one quantum operation on a neutral atom qubit of the first set of neutral atom qubits comprises operating the optical system to apply a Rabi oscillation pulse to the neutral atom qubit.
Aspect 28. The system of aspect 27, wherein the first control parameter is a frequency of the Rabi oscillation pulse.
Aspect 29. The system of aspect 21, wherein the first control parameter parameterizes a hardware setting of the optical system that controls a frequency of one or more laser beams produced by the optical system.
Aspect 30. The system of aspect 21, wherein executing the quantum circuit on the first set of neutral atom qubits comprises: performing a state preparation operation on each neutral atom qubit of the first set of neutral atom qubits, which initializes a state of each neutral atom qubit; performing the at least one quantum operation that is parameterized by the first control parameter on each neutral atom qubit of the first set of neutral atom qubits; and performing a readout operation that measures the state of each neutral atom qubit of the first set of neutral atom qubits subsequent to performing the at least one quantum operation that is parameterized by the first control parameter.
Aspect 31. The system of aspect 30, wherein performing the at least one quantum operation that is parameterized by the first control parameter on each neutral atom qubit of the first set of neutral atom qubits comprises, for each neutral atom qubit of the first set of neutral atom qubits, operating the optical system to direct a Rydberg excitation pulse onto the neutral atom qubit, and wherein the first control parameter is a duration or a frequency of the Rydberg excitation pulse.
Aspect 32. The system of aspect 21, wherein executing the at least one quantum operation on a neutral atom qubit of the first set of neutral atom qubits comprises operating the optical system to apply a single neutral atom qubit gate to the neutral atom qubit.
Aspect 33. The system of aspect 21, wherein executing the at least one quantum operation on the first set of neutral atom qubits comprises operating the optical system to apply plurality of two neutral atom qubit gates to pairs of neutral atom qubits of the first set of neutral atom qubits.
Aspect 34. A system comprising: an optical system configured to trap, and manipulate quantum states of, a plurality of neutral atom qubits, wherein operation of the optical system is controlled by at least a first control parameter; and at least one controller configured to: determine calibrated values of the first control parameter for each neutral atom qubit of a first set of neutral atom qubits, wherein determining the calibrated values of the first control parameter for each neutral atom qubit of the first set of neutral atom qubits comprises: executing a sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the sequence of the quantum circuit; and calculate calibrated values of the first control parameter for each neutral atom qubit of a second set of neutral atom qubits based on the determined calibrated values of the first control parameter for each neutral atom qubit of the first set of neutral atom qubits and based on at least one correlated property between the neutral atom qubit of the second set of neutral atom qubits and the first set of neutral atom qubits.
Aspect 35. The system of aspect 34, wherein the at least one controller is configured to execute the sequence of the quantum circuit on the first set of neutral atom qubits by operating the optical system to direct at least one Raman laser onto the first set of neutral atom qubits.
Aspect 36. The system of aspect 34, wherein the at least one controller is configured to execute the sequence of the quantum circuit on the first set of neutral atom qubits by operating the optical system to direct light onto the first set of neutral atom qubits, and to subsequently observe fluorescence light produced by the first set of neutral atom qubits.
Aspect 37. The system of aspect 34, wherein the optical system comprises at least one laser and at least one spatial light modulator (SLM).
Aspect 38. The system of aspect 34, wherein the first control parameter is a hardware setting of the optical system.
Aspect 39. The system of aspect 34, wherein executing the at least one quantum operation on a neutral atom qubit of the first set of neutral atom qubits comprises operating the optical system to apply a Rabi oscillation pulse to the neutral atom qubit.
Aspect 40. The system of aspect 34, wherein the at least one controller is configured to calculate the calibrated values of the first control parameter for each neutral atom qubit of the second set of neutral atom qubits by extrapolating and/or interpolating one or more of the calibrated values of the first control parameter for each neutral atom qubit of the first set of neutral atom qubits.
Aspect 41. The system of aspect 34, wherein the quantum circuit is a first quantum circuit, and wherein the at least one controller is further configured to: determine calibrated values of a second control parameter for each neutral atom qubit of a third set of neutral atom qubits, disjoint from the first set of neutral atom qubits, wherein determining the calibrated values of the second control parameter for each neutral atom qubit of the third set of neutral atom qubits comprises, concurrently with executing the sequence of the first quantum circuit on the first set of neutral atom qubits: executing a sequence of a second quantum circuit on the third set of neutral atom qubits at least in part by operating the optical system, wherein the second quantum circuit comprises one or more quantum operations including at least one quantum operation that is parameterized by the second control parameter, and wherein the second quantum circuit is executed with a plurality of different values of the second control parameter when executing the sequence of the second quantum circuit; and calculating calibrated values of the second control parameter for each neutral atom qubit of the second set of neutral atom qubits based on the determined calibrated values of the second control parameter for each neutral atom qubit of the third set of neutral atom qubits and based on at least one correlated property between the third set of neutral atom qubits and the second set of neutral atom qubits.

Such alterations, modifications, and improvements are intended to be part of this disclosure and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Aspects of the above-described embodiments of the technology described herein can be implemented in any of numerous ways. For example, aspects of the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method comprising:
determining calibrated values of a first control parameter for each qubit of a plurality of qubits, the plurality of qubits including a first set of qubits and a second set of qubits disjoint from the first set of qubits, wherein determining the calibrated values of the first control parameter for each qubit of the plurality of qubits comprises:
executing a first sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit; and
concurrently with executing the first sequence of the quantum circuit on the first set of qubits, executing a second sequence of the quantum circuit on the second set of qubits using the quantum information processor, wherein the quantum circuit is executed with a plurality of different values of the first control parameter when executing the second sequence of the quantum circuit.

2. The method of claim 1, further comprising determining a value of a cost function subsequent to each execution of the first sequence of the quantum circuit, and updating a value of the first control parameter based on the determined value of the cost function.

3. The method of claim 1, wherein the plurality of qubits is a plurality of neutral atom qubits arranged in optical traps, and wherein executing the first sequence of the quantum circuit comprises operating an optical system to direct one or more laser beams onto qubits of the first set of qubits.

4. The method of claim 3, wherein executing the at least one quantum operation on a qubit of the first set of qubits comprises operating the optical system to apply a Rabi oscillation pulse to the qubit.

5. The method of claim 1, wherein executing the quantum circuit on the first set of qubits comprises:
performing a state preparation operation on each qubit of the first set of qubits, which initializes a state of each qubit;
performing the at least one quantum operation that is parameterized by the first control parameter on each qubit of the first set of qubits; and
performing a readout operation that measures the state of each qubit of the first set of qubits subsequent to performing the at least one quantum operation that is parameterized by the first control parameter.

6. The method of claim 5,
wherein the plurality of qubits is a plurality of neutral atom qubits,
wherein performing the at least one quantum operation that is parameterized by the first control parameter on each qubit of the first set of qubits comprises, for each qubit of the first set of qubits, operating an optical system to direct a Rydberg excitation pulse onto the qubit, and
wherein the first control parameter is a duration or a frequency of the Rydberg excitation pulse.

7. A method comprising:
determining calibrated values of a first control parameter for each qubit of a first set of qubits, wherein determining the calibrated values of the first control parameter for each qubit of the first set of qubits comprises:
executing a sequence of a quantum circuit on the first set of qubits using a quantum information processor, wherein the quantum circuit comprises one or more quantum operations including at least one quantum operation that is parameterized by the first control parameter, and wherein the quantum circuit is executed with a plurality of different values of the first control parameter when executing the sequence of the quantum circuit; and
calculate calibrated values of the first control parameter for each qubit of a second set of qubits based on the determined calibrated values of the first control parameter for each qubit of the first set of qubits and based on at least one correlated property between the qubit of the second set of qubits and the first set of qubits.

8. The method of claim 7, further comprising determining a value of a cost function subsequent to each execution of the quantum circuit in the sequence, and updating a value of the first control parameter based on the determined value of the cost function.

9. The method of claim 7, wherein the at least one correlated property includes a relative spatial position between the qubit of the second set of qubits and the first set of qubits.

10. The method of claim 7, wherein calculating the calibrated values of the first control parameter for each qubit of the second set of qubits comprises extrapolating and/or interpolating one or more of the calibrated values of the first control parameter for each qubit of the first set of qubits.

11. The method of claim 7, wherein the quantum circuit is a first quantum circuit, and wherein the method further comprises:
determining calibrated values of a second control parameter for each qubit of a third set of qubits, disjoint from the first set of qubits, wherein determining the calibrated values of the second control parameter for each qubit of the third set of qubits comprises, concurrently with executing the sequence of the first quantum circuit on the first set of qubits:
executing a sequence of a second quantum circuit on the third set of qubits using the quantum information processor, wherein the second quantum circuit comprises one or more quantum operations including at least one quantum operation that is parameterized by the second control parameter, and wherein the second quantum circuit is executed with a plurality of different values of the second control parameter when executing the sequence of the second quantum circuit; and
calculating calibrated values of the second control parameter for each qubit of the second set of qubits based on the determined calibrated values of the second control parameter for each qubit of the third set of qubits and based on at least one correlated property between the third set of qubits and the second set of qubits.

12. A system comprising:
an optical system configured to trap, and manipulate quantum states of, a plurality of neutral atom qubits, wherein operation of the optical system is controlled by at least a first control parameter; and
at least one controller configured to:
determine calibrated values of the first control parameter for each of the plurality of neutral atom qubits, the plurality of neutral atom qubits including a first set of neutral atom qubits and a second set of neutral atom qubits disjoint from the first set of neutral atom qubits, wherein determining the calibrated values of the first control parameter for each neutral atom qubit of the plurality of neutral atom qubits comprises:
executing a first sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the first sequence of the quantum circuit; and
concurrently with executing the first sequence of the quantum circuit on the first set of neutral atom qubits, executing a second sequence of the quantum circuit on the second set of neutral atom qubits at least in part by operating the optical system, wherein the quantum circuit is executed with a plurality of different values of the first control parameter when executing the second sequence of the quantum circuit.

13. The system of claim 12, wherein the at least one controller is configured to execute the first sequence of the quantum circuit on the first set of neutral atom qubits by operating the optical system to direct at least one Raman laser onto the first set of neutral atom qubits.

14. The system of claim 12, wherein the at least one controller is configured to execute the first sequence of the quantum circuit on the first set of neutral atom qubits by operating the optical system to direct light onto the first set of neutral atom qubits, and to subsequently detect fluorescence light produced by the first set of neutral atom qubits.

15. The system of claim 12, wherein executing the at least one quantum operation on a neutral atom qubit of the first set of neutral atom qubits comprises operating the optical system to apply a Rabi oscillation pulse to the neutral atom qubit.

16. The system of claim 12, wherein executing the quantum circuit on the first set of neutral atom qubits comprises:
performing a state preparation operation on each neutral atom qubit of the first set of neutral atom qubits, which initializes a state of each neutral atom qubit;
performing the at least one quantum operation that is parameterized by the first control parameter on each neutral atom qubit of the first set of neutral atom qubits; and
performing a readout operation that measures the state of each neutral atom qubit of the first set of neutral atom qubits subsequent to performing the at least one quantum operation that is parameterized by the first control parameter.

17. The system of claim 16,
wherein performing the at least one quantum operation that is parameterized by the first control parameter on each neutral atom qubit of the first set of neutral atom qubits comprises, for each neutral atom qubit of the first set of neutral atom qubits, operating the optical system to direct a Rydberg excitation pulse onto the neutral atom qubit, and
wherein the first control parameter is a duration or a frequency of the Rydberg excitation pulse.

18. A system comprising:
an optical system configured to trap, and manipulate quantum states of, a plurality of neutral atom qubits, wherein operation of the optical system is controlled by at least a first control parameter; and
at least one controller configured to:
determine calibrated values of the first control parameter for each neutral atom qubit of a first set of neutral atom qubits, wherein determining the calibrated values of the first control parameter for each neutral atom qubit of the first set of neutral atom qubits comprises:
executing a sequence of a quantum circuit on the first set of neutral atom qubits at least in part by operating the optical system, wherein the quantum circuit comprises one or more quantum operations including at least one quantum operation that is parameterized by the first control parameter, and wherein the quantum circuit is executed with a plurality of different values of the first control parameter when executing the sequence of the quantum circuit; and
calculate calibrated values of the first control parameter for each neutral atom qubit of a second set of neutral atom qubits based on the determined calibrated values of the first control parameter for each neutral atom qubit of the first set of neutral atom qubits and based on at least one correlated property between the neutral atom qubit of the second set of neutral atom qubits and the first set of neutral atom qubits.

19. The system of claim 18, wherein the at least one controller is configured to execute the sequence of the quantum circuit on the first set of neutral atom qubits by operating the optical system to direct light onto the first set of neutral atom qubits, and to subsequently detect fluorescence light produced by the first set of neutral atom qubits.

20. The system of claim 18, wherein the quantum circuit is a first quantum circuit, and wherein the at least one controller is further configured to:
determine calibrated values of a second control parameter for each neutral atom qubit of a third set of neutral atom qubits, disjoint from the first set of neutral atom qubits, wherein determining the calibrated values of the second control parameter for each neutral atom qubit of the third set of neutral atom qubits comprises, concurrently with executing the sequence of the first quantum circuit on the first set of neutral atom qubits:
executing a sequence of a second quantum circuit on the third set of neutral atom qubits at least in part by operating the optical system, wherein the second quantum circuit comprises one or more quantum operations including at least one quantum operation that is parameterized by the second control parameter, and wherein the second quantum circuit is executed with a plurality of different values of the second control parameter when executing the sequence of the second quantum circuit; and
calculating calibrated values of the second control parameter for each neutral atom qubit of the second set of neutral atom qubits based on the determined calibrated values of the second control parameter for each neutral atom qubit of the third set of neutral atom qubits and based on at least one correlated property between the third set of neutral atom qubits and the second set of neutral atom qubits.
